(19) United States
(12) Patent Application Publication
(10) Pub. No.: US 2025/0284998 A1
(43) Pub. Date: Sep. 11, 2025

(54) MIXTURE OF EXPERTS ENERGY BASED MODEL GADGET

(71) Applicant: Extropic Corp., Austin, TX (US)

(72) Inventors: Christopher Chamberland, Austin, TX (US); Guillaume Verdon-Akzam, San Francisco, CA (US)

(73) Assignee: Extropic Corp., Austin, TX (US)

(21) Appl. No.: 19/069,075

(22) Filed: Mar. 3, 2025

Related U.S. Application Data
(60) Provisional application No. 63/562,570, filed on Mar. 7, 2024.

(51) Int. Cl. G06N 10/60; G06N 10/40

(52) U.S. Cl. CPC G06N 10/60; G06N 10/40

(57) ABSTRACT

A thermodynamic mixture of experts gadget includes a SoftMax gadget, multiple energy-based models for processing data, and a summation gadget, also called a Selection of Experts gadget. The SoftMax gadget generates one-hot encoded vectors, which correspond to particular ones of the energy-based models for processing data. The outputs of the energy-based models for processing data, in combination with the one-hot encoded vectors, are inputs to the summation gadget, which generates output that is processed data, processed by energy-based models selected by the SoftMax gadget.

### RELATED APPLICATION

This application claims benefit of priority to U.S. Provisional Application Ser. No. 63/562,570, entitled “Mixture of Experts Energy Based Model Gadget,” filed Mar. 7, 2024, and which is incorporated herein by reference in its entirety.

### BACKGROUND

### Description of Related Art

Various algorithms, such as machine learning algorithms, often use statistical probabilities to make decisions or to model systems. Some such learning algorithms may use Bayesian statistics, or may use other statistical models that have a theoretical basis in natural phenomena. Also, machine learning algorithms themselves may be implemented using Bayesian statistics, or may use other statistical models that have a theoretical basis in natural phenomena.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

As an alternative, algorithms may be performed using thermodynamic computers. However, communication between multiple algorithms implemented on a thermodynamic computing device and/or communications between thermodynamic computing devices may require converting information into a classical computing device form, thus reducing at least some of the benefits of a thermodynamic computer implementation.

### BRIEF DESCRIPTION OF THE DRAWINGS

FIG. 1A is a high-level block diagram of a thermodynamic chip arrangement for a gating portion for a mixture of experts gadget, according to some embodiments.

FIG. 1B is a high-level block diagram of a thermodynamic chip arrangement for an output combination portion of the mixture of experts gadget, illustrated separately from a coupled gating portion, according to some embodiments.

FIG. 1C is a block diagram of a combination between the output combination portion of a mixture of experts gadget and the gating portion of the mixture of experts gadget, according to some embodiments.

FIG. 1D is a block diagram of a set of SoftMax output oscillators in a particular one-hot vector configuration which selects a particular energy-based model, according to some embodiments.

FIG. 1E is the block diagram of the combination of the output combination portion of a mixture of experts gadget and the gating portion of the mixture of experts gadget with a selection of an energy-based model based on the one-hot vector of the SoftMax output oscillators, according to some embodiments.

FIG. 1F is a block diagram of a configuration for a summation gadget which accepts results from a set of energy-based models based on a gating model such as a SoftMax gadget, according to some embodiments.

FIG. 2A is a block diagram of oscillators of a SoftMax gadget, a particular energy-based model, relay oscillators, and a summation gadget at a first time (T₁) such as prior to couplings between the oscillators being established, according to some embodiments.

FIG. 2B is a block diagram of oscillators of the SoftMax gadget, a first particular energy-based model, the relay oscillators, and the summation gadget at a second time, such as after couplings between the output oscillators of the SoftMax gadget, the relay oscillators, and the output oscillators of the particular energy-based model are established and while thermodynamic evolution is occurring, according to some embodiments.

FIG. 2C is a block diagram of oscillators of the SoftMax gadget, a second particular energy-based model, the relay oscillators, and the summation gadget at the second time, such as after couplings between the output oscillators of the SoftMax gadget, the relay oscillators, and the output oscillators of the particular energy-based model are established and while thermodynamic evolution is occurring, according to some embodiments.

FIG. 2D is a block diagram of oscillators of the SoftMax gadget, a third particular energy-based model, the relay oscillators, and the summation gadget at the second time, such as after couplings between the output oscillators of the SoftMax gadget, the relay oscillators, and the output oscillators of the particular energy-based model are established and while thermodynamic evolution is occurring, according to some embodiments.

FIG. 2E is a block diagram of oscillators of the SoftMax gadget, a third particular energy-based model, the relay oscillators, and the summation gadget at a third time, such as after couplings between the relay oscillators and input oscillators of the summation gadget are established and while thermodynamic evolution is occurring, according to some embodiments.

FIG. 2F is a block diagram of oscillators of the SoftMax gadget, a first particular energy-based model, the relay oscillators, and the summation gadget at a fourth time, such as after thermodynamic equilibrium is reached and a set of data sample receiver oscillators 200 are able to take a data sample representing the expectation value vector from the summation gadget, according to some embodiments.

FIG. 3 illustrates an example coupling for an analog SoftMax gadget, wherein ancilla oscillators (ϕₐ_{ⱼ}_{^{(l)}}) are used to emulate an all-to-all coupling between input/output oscillators (ϕ_{b}_{ⱼ}) of the analog SoftMax gadget, wherein the input/output oscillators (ϕ_{b}_{ⱼ}) and the additional oscillators (ϕₐ_{ⱼ}_{^{(l)}}) have a reduced degree of connectivity as compared to input/output oscillators (ϕ_{b}_{ⱼ}) used in an all-to-all coupling for a similar sized array of input/output oscillators, according to some embodiments.

FIG. 4 illustrates graphs of potentials for a given oscillator of the analog SoftMax gadget, wherein the given oscillator has a dual-well potential. FIG. 4 further illustrates how increasing the parameter A₁ in an engineered potential for the analog SoftMax gadget causes the walls and intermediate barrier between the two wells of the dual-well potential to be more steep, such that the dual-well oscillator is more likely to evolve to a value of 0 or 1 as required by the engineered potential for the analog SoftMax gadget, according to some embodiments.

FIG. 5 illustrates an example attention block of a machine learning model, that may be implemented in an analog manner using one or more thermodynamic chips, wherein an analog mixture of experts gadget is used at least in part to implement an addition and normalization layer, according to some embodiments.

FIG. 6 is a flowchart illustrating a process for implementing a mixture of experts function using an analog SoftMax gadget, a set of energy-based models, and an analog summation gadget, according to some embodiments.

FIG. 7A illustrates additional details of a relay gadget implemented using a thermodynamic chip, wherein the relay gadget is configured to relay thermodynamic information between a first energy-based model (EBM), such as one energy-based model from a set of energy-based models, and a second energy-based model (EBM), such as an analog mixture of experts gadget, according to some embodiments.

FIG. 7B is high-level diagram similar to FIG. 7A, wherein the relay gadget does not include a bias oscillator, according to some embodiments.

FIG. 8 is a high-level flowchart illustrating a process of relaying thermodynamic information between an output oscillator, such as of a first energy-based model (EBM), and an input oscillator, such as of an analog SoftMax gadget, according to some embodiments.

FIG. 9 is a high-level diagram illustrating an output oscillator, an input oscillator, and a relay gadget, wherein the relay gadget comprises a group of relay oscillators and is configured to relay expectation values of thermodynamic information between the output oscillator and the input oscillator, according to some embodiments.

FIG. 10 is a high-level diagram illustrating a spatial analogue relay gadget, wherein respective ones of relay oscillators of a group of relay oscillators are configured to store respective sample values of an output oscillator, according to some embodiments.

FIG. 11 is a high-level diagram illustrating a temporal analogue relay gadget, wherein a group of relay oscillators comprises a single relay oscillator, according to some embodiments.

FIG. 12 is a high-level diagram illustrating a series analogue relay gadget, wherein a group of relay oscillators comprises a plurality of relay oscillators arranged in series, according to some embodiments.

FIG. 13A illustrates example couplings between visible neurons of an energy-based model (EBM), according to some embodiments.

FIG. 13B illustrates example couplings between visible neurons and non-visible neurons (e.g., hidden neurons) of an energy-based model (EBM), according to some embodiments.

FIG. 14 is high-level diagram illustrating a process of determining weights and biases to be used in an energy-based model (EBM), wherein the weights and biases are determined using measurement values for synapse oscillators, according to some embodiments.

FIG. 15 is high-level diagram illustrating a process of determining weights and biases to be used in an energy-based model (EBM), wherein the weights and biases are computed using a classical computing device, according to some embodiments.

FIG. 16 is high-level diagram illustrating an example neuro-thermodynamic computer comprising a thermodynamic chip (e.g., that implements one or more energy-based models (EBMs), an analog SoftMax gadget, a mixture of experts gadget, and a relay gadget) included in a dilution refrigerator and coupled to a classical computing device in an environment external to the dilution refrigerator, according to some embodiments.

FIG. 17 is high-level diagram illustrating an example neuro-thermodynamic computer comprising a thermodynamic chip (e.g., that implements one or more energy-based models (EBMs), an analog SoftMax gadget, a mixture of experts gadget, and a relay gadget) included in a dilution refrigerator and coupled to a classical computing device that is also included in the dilution refrigerator, according to some embodiments.

FIG. 18 is high-level diagram illustrating an example neuro-thermodynamic computer comprising one or more thermodynamic chips (e.g., that implement one or more energy-based models (EBMs), an analog SoftMax gadget, a mixture of experts gadget, and a relay gadget) coupled to a classical computing device in an environment other than a dilution refrigerator, according to some embodiments.

FIG. 19 is a high-level diagram illustrating oscillators included in a substrate of a thermodynamic chip and a mapping of the oscillators to logical neurons or synapses of the thermodynamic chip, according to some embodiments.

FIG. 20 is an additional high-level diagram illustrating oscillators included in a substrate of a thermodynamic chip mapped to logical neurons, weights, and biases (e.g., synapses) of a neuro-thermodynamic computing system, according to some embodiments.

FIG. 21 illustrates an example apparatus for measuring positions of oscillators of a thermodynamic chip using a flux read-out device, according to some embodiments.

FIG. 22 illustrates an example apparatus for measuring momentums of oscillators of a thermodynamic chip using a charge read-out device, according to some embodiments.

FIG. 23 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to methods, systems, and an apparatus for processing data using a thermodynamic chip implementation of multiple energy-based models. The energy-based models that process data, which are called experts, are gated by a SoftMax energy-based model gadget. The output of the experts is combined according to the SoftMax gating by a summation energy-based model. The energy models used to generate the output of the experts may collectively be called a mixture of experts gadget. A thermodynamic computer may process data using a set of the energy-based models known as experts. For particular types of data, a particular expert of the set may be the best expert of the set of experts for processing the data. An analog SoftMax gadget and an analog summation gadget may be used in combination to select energy-based models to process the data.

The mixture of experts gadget may enable greater efficiency in a thermodynamic computer by reducing the training costs for deep learning. The mixture of experts gadget may include a gating function to select particular models based on input data. The gating function may be implemented by a SoftMax gadget or a similar selection gadget, and may use modified input data which has been modified from initial input data by an energy-based model as part of the gating function. The gating function may provide an indication of which energy-based model's output the mixture of experts gadget is to use as an output. The gating function may provide weights that the mixture of experts gadget may apply to the outputs of the set of energy-based models to generate a total output.

Embodiments described herein further relate to performing computer operations using a thermodynamic chip and more specifically to relaying thermodynamic information between components, such as components of a neuro-thermodynamic computing device, while maintaining the information in a thermodynamic state. This can be contrasted with other approaches to communicate information that involve reading out thermodynamic information, such as using a classical computing device, and then relaying the information in classical form. For example, the ability to relay thermodynamic information directly between components in a neuro-thermodynamic computer avoids issues associated with readout to a classical computing device, such as read-out error, loss of information, and/or delays associated with performing readout. Moreover, if the information is to be used by another component of a neuro-thermodynamic computing device, relay of the information in a thermodynamic state avoids other delays such as would be incurred if required to initialize a receiving component to have an initial state corresponding to a state of the thermodynamic information that was read out from another component, wherein the relayed information is not already in a thermodynamic state. In some embodiments, such relay techniques as described herein may be used to relay thermodynamic information between energy-based models (EBMs). Such energy-based models (EBMs) may include trained models that evolve according to Langevin dynamics, and which may be used to generate inferences, such as machine learning (ML) inferences. For example, an ML model used to generate a ML inference may be physically implemented as a trained energy-based model (EBM).

An EBM may be an analog configuration of oscillators which may process and transfer information through connections to other oscillators. One type of information which the oscillators may use is the degrees of freedom of an oscillator, which may be represented by ϕ. The EBMs may process the input data according to internal specifications. The internal specifications may be specific to the function of the EBMs, and may be specific to particular data types. A Hamiltonian or potential of an EBM may correspond to a function, such that an EBM with a particular Hamiltonian or potential is configured to execute the function associated with the Hamiltonian or potential. The EBMs may be analog devices implementing strategies used in deep learning for machine learning models, as are known for classical computing. A SoftMax gadget and summation gadget are EBMs, and will be referred to by name to avoid confusion with the experts, which are the set of energy-based models that the SoftMax gadget selects between for the summation gadget.

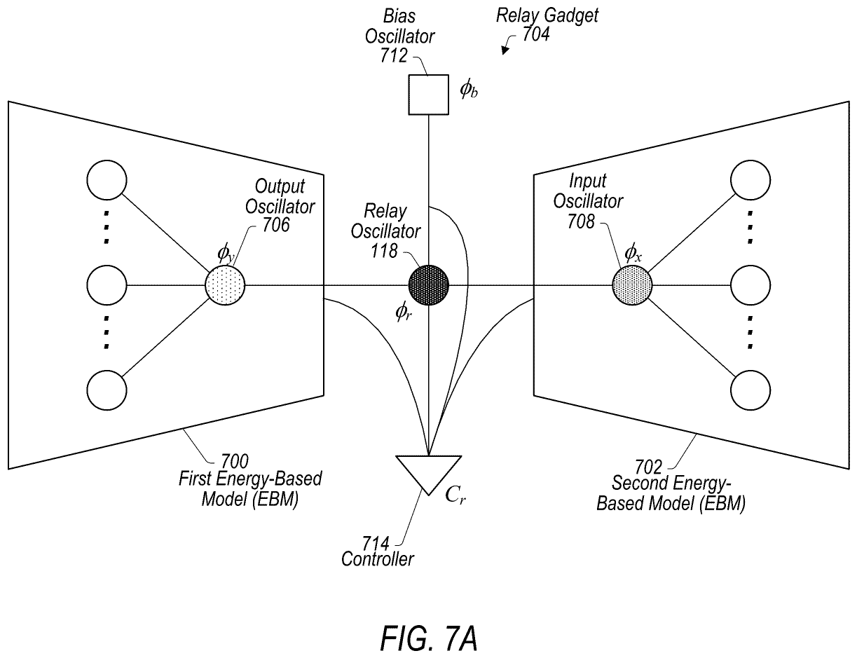

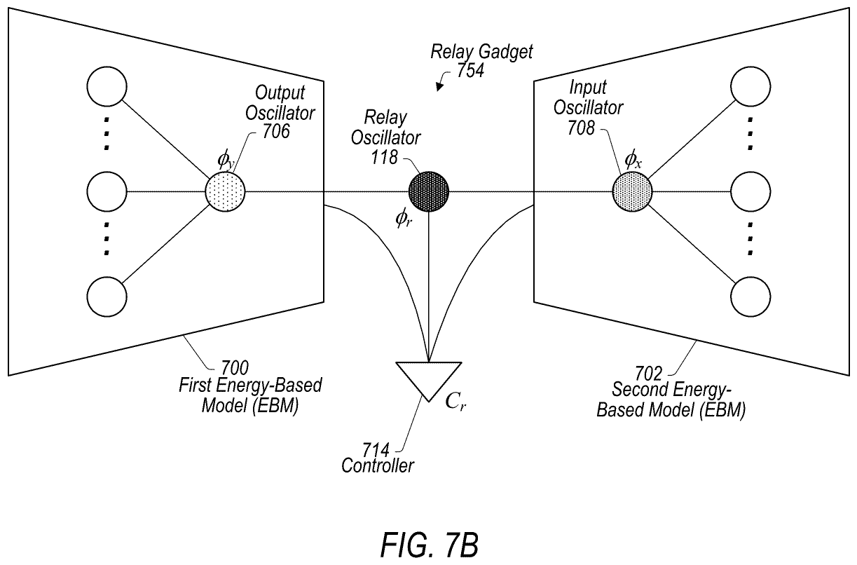

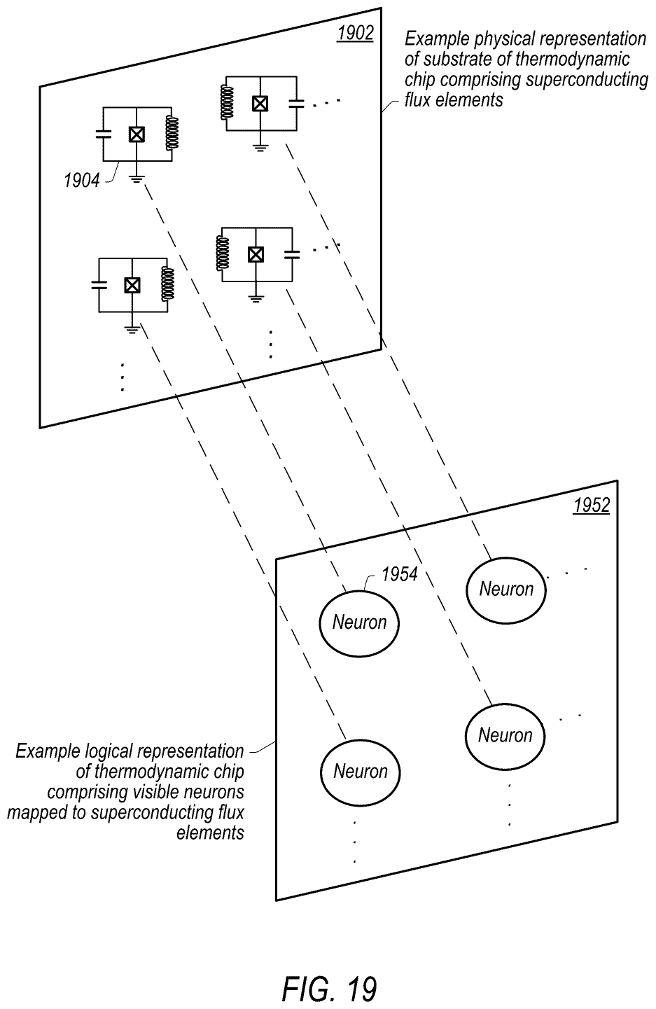

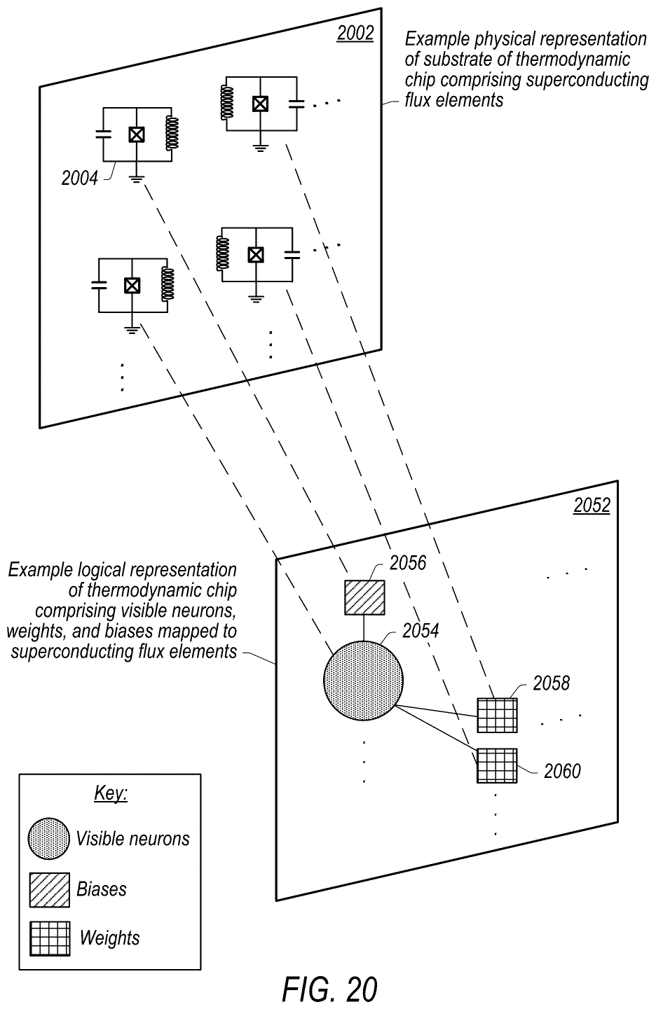

Oscillators as used herein are described further at FIGS. 19-20. A thermodynamic computer may use relay oscillators or relay gadgets to move information from one energy-based model to another. Relay oscillators and relay gadgets are described further at FIGS. 7A-12.

In some embodiments, a neuro-thermodynamic processor may be configured such that learning algorithms for learning parameters of an energy-based model may be applied using Langevin dynamics. For example, as described herein, a thermodynamic chip of a neuro-thermodynamic processor may be configured such that, given a Hamiltonian that describes an energy-based model, weights and biases (e.g., synapses) may be calculated based on measurements taken from the thermodynamic chip as it naturally evolves according to Langevin dynamics. For example, a positive phase term, a negative phase term, and associated gradients needed to determine updated weights and biases for the energy-based model may be simply computed on an accompanying classical computing device, such as a field programmable gate array (FPGA) or application specific integrated circuit (ASIC), based on measurements taken from the oscillators of the thermodynamic chip. Such calculations performed on the accompanying classical computing device may be simple and non-complex as compared to other approaches that use the classical computing device to determine statistical probabilities (e.g., without using a thermodynamic chip). Also, in some embodiments, weights and biases used in an energy-based model may be determined iteratively, for example wherein a classical computing device is used to generate updated weights and biases, and wherein resulting inference performance is compared to training data to determine whether additional iterative learning is needed.

In some embodiments, physical elements of a thermodynamic chip may be used to physically model evolution according to Langevin dynamics. For example, in some embodiments, a thermodynamic chip includes a substrate comprising oscillators implemented using superconducting flux elements. The oscillators may be mapped to neurons (visible or hidden) that “evolve” according to Langevin dynamics. For example, the oscillators of the thermodynamic chip may be initialized in a particular configuration and allowed to thermodynamically evolve. As the oscillators “evolve” degrees of freedom of the oscillators may be sampled. Values of these sampled degrees of freedom may represent, for example, vector values for neurons or synapses that evolve according to Langevin dynamics. For example, algorithms that use stochastic gradient optimization and require sampling during training, such as those proposed by Welling and Teh, and/or other algorithms, such as natural gradient descent, mirror descent, etc. may be implemented using a thermodynamic chip. In some embodiments, a thermodynamic chip may enable such algorithms to be implemented directly by sampling the neurons and/or synapses (e.g., degrees of freedom of the oscillators of the substrate of the thermodynamic chip) without having to calculate statistics to determine probabilities. As another example, thermodynamic chips may be used to perform autocomplete tasks, such as those that use Hopfield networks, which may be implemented using the Welling and Teh algorithm. For example, visible neurons may be arranged in a fully connected graph (such as a Hopfield network, etc.), and the values of the auto complete task may be learned using the Welling and Teh algorithm. In some embodiments, a relay gadget may be used to sample visible neurons of a first energy-based model (EBM) and provide the sampled thermodynamic information as an input to another energy-based model (EBM).

In some embodiments, a thermodynamic chip includes superconducting flux elements arranged in a substrate, wherein the thermodynamic chip is configured to modify magnetic fields that couple respective ones of the oscillators with other ones of the oscillators. In some embodiments, non-linear (e.g., anharmonic) oscillators are used that have dual-well potentials. These dual-well oscillators may be mapped to neurons of a given energy-based model that the thermodynamic chip is being used to implement. Also, in some embodiments, at least some of the oscillators may be harmonic oscillators with single-well potentials. In some embodiments, oscillators may be implemented using superconducting flux elements with varying amounts of non-linearity. In some embodiments, an oscillator may have a single well potential, a dual-well potential, or a potential somewhere in a range between a single-well potential and a dual-well potential. In some embodiments, visible neurons may be mapped to oscillators having a single well potential, a dual-well potential, or a potential somewhere in a range between a single-well potential and a dual-well potential.

In some embodiments, oscillators of a thermodynamic chip may also be used to represent values of weights and biases of the energy-based model. Thus, weights and biases that describe relationships between neurons may also be represented as dynamical degrees of freedom, e.g., using oscillators of the thermodynamic chip (e.g., synapse oscillators).

In some embodiments, parameters of an energy-based model or other learning algorithm may be learned through evolution of the oscillators of a thermodynamic chip.

As mentioned above, in some embodiments, the weights and biases of an energy-based model may be dynamical degrees of freedom (e.g., oscillators of a thermodynamic chip), in addition to neurons (hidden or visible) being dynamic degrees of freedom (e.g., represented by other oscillators of the thermodynamic chip). In such configurations, gradients needed for learning algorithms can be obtained by performing sampling of the synapse oscillators, such as position samples or momentum samples. For example, measurements of the synapse oscillators (position or momentum) performed on a time scale proportional to a thermalization time of the synapse oscillators, or on shorter time scales than the thermalization times of the synapse oscillators, can be used to compute time-averaged gradients in addition to space averaged gradients. In some embodiments, the variance of the time averaged or space averaged gradient (determined using synapse oscillator measurements) scales as 1/t where t is the total measurement time. These gradients can be used to calculate new weights and bias values that may be used as synapse values in an updated version of the energy-based model. The process of making measurements and determining updated weights and biases may be repeated multiple times until a learning threshold for the energy-based model has been reached.

For example, there are various learning algorithms where one must use both positive and negative phase terms to perform parameter updates. For instance, in the implementation by Welling and Teh the parameters are updated as follows:

$${θ}_{t + 1} = {θ}_{t} + \frac{{t}_{}}{2} ( - {∇}_{{θ}_{t}} {ℰ}_{p} ( {θ}_{t} ) - N \frac{1}{n} {\sum }_{i = 1}^{n} {∇}_{{θ}_{t}} ℰ ( {θ}_{t} , {x}_{{t}_{i}} ) - {𝔼}_{x ∼ {p}_{{θ}_{t}} ( x )} [ {∇}_{{θ}_{t}} ℰ ( {θ}_{t} , x ) ] ) + {η}_{t}$$

where [symbol] ₚ(θₜ) is some prior potential and the probability distribution for an energy-based model (EBM) with parameters θₜ given by pθₜ(x)= [symbol] ^{(θ}^{_{t,}}^{x)}/Z, where Z is a partition function. In the above equation, the first gradient term, where the visible nodes are clamped to the data will be referred to as the positive phase term. The second gradient term, where the visible nodes are sampled from x˜pθₜ(x) will be referred to as the negative phase term (e.g., where the visible nodes are unclamped). When hidden neurons are present, the parameter update rule is given by:

$${θ}_{t + 1} = {θ}_{t} + \frac{{t}_{}}{2} ( - {∇}_{{θ}_{t}} {ℰ}_{p} ( {θ}_{t} ) - N \frac{1}{n} {\sum }_{i = 1}^{n} {𝔼}_{z ∼ {p}_{{θ}_{t}} ( z \vert {x}_{{t}_{i}} )} [ {∇}_{{θ}_{t}} ℰ ( {θ}_{t} , {x}_{{t}_{i}} , z ) ] - {𝔼}_{( x , z ) ∼ {p}_{{θ}_{t}} ( x , z )} [ {∇}_{{θ}_{t}} ℰ ( {θ}_{t} , x , z ) ] ) + {η}_{t}$$

For a neuro-thermodynamic processor, which includes visible neurons coupled via weights and biases that are also represented by degrees of freedom (e.g., synapse oscillators), the dynamics of the system for a three-body coupling between the synapse oscillators and the neuron oscillators (visible or hidden) are described by the following Hamiltonian:

$${H}_{total} = {\sum }_{j ∈ {𝒱}_{v i s}} ( \frac{{p}_{{n}_{j}}^{2}}{2 {m}_{{n}_{j}}^{( v )}} + {{E}_{L}^{( v )} ( {ϕ}_{{n}_{j}} - {\tilde{ϕ}}_{L}^{( v )} )}^{2} + {E}_{J 0}^{( v )} cos ( {\tilde{ϕ}}_{D C}^{( v )} / 2 ) ( 1 - cos ( {ϕ}_{{n}_{j}} ) ) ) + {\sum }_{k , l ∈ ℰ} ( \frac{{p}_{{s}_{j}}^{2}}{2 {m}_{{s}_{k , l}}^{( w )}} + {{E}_{L}^{( w )} ( {φ}_{{s}_{k , l}} - {\tilde{ϕ}}_{L}^{( w )} )}^{2} + {E}_{J 0}^{( w )} cos ( {\tilde{ϕ}}_{D C}^{( w )} / 2 ) ( 1 - cos ( {ϕ}_{{s}_{k , l}} ) ) ) + {\sum }_{j ∈ {𝒱}_{v i s}} ( \frac{{p}_{{b}_{j}}^{2}}{2 {m}_{{b}_{j}}^{( b )}} + {{E}_{L}^{( b )} ( {ϕ}_{{b}_{j}} - {\tilde{ϕ}}_{L}^{( b )} )}^{2} + {E}_{J 0}^{( b )} cos ( {\tilde{ϕ}}_{D C}^{( b )} / 2 ) ( 1 - cos ( {ϕ}_{{b}_{j}} ) ) ) + ( α {\sum }_{\{ k , l \} ∈ ℰ} {ϕ}_{{s}_{k l}} {ϕ}_{{n}_{k}} {ϕ}_{{n}_{l}} + β {\sum }_{j ∈ 𝒱} {ϕ}_{{n}_{j}} {ϕ}_{{b}_{j}} )$$

Note that the above Hamiltonian uses a representation of couplings between neuron oscillators and synapse oscillators given by the terms proportional to alpha and beta. However, in some embodiments, a Hamiltonian with more general terms may be used. The above Hamiltonian is given as an example of an energy-based model, but others may be used within the scope of the present disclosure.

Broadly speaking, classes of algorithms that may benefit from implementation using a thermodynamic chip include those algorithms that involve probabilistic inference. Such probabilistic inferences (which otherwise would be performed using a CPU or GPU) may instead be delegated to the thermodynamic chip for a faster and more energy efficient implementation. At a physical level, the thermodynamic chip harnesses electron fluctuations in superconductors coupled in flux loops to model Langevin dynamics. In some embodiments, architectures such as those described herein may resemble a partial self-learning architecture, wherein classical computing device(s) (e.g., a FPGA, ASIC, etc.) may be relied upon only to perform simple tasks such as summing measured values and performing other non-compute intensive operations in order to implement a learning algorithm.

Note that in some embodiments, electro-magnetic or mechanical (or other suitable) oscillators may be used. A thermodynamic chip may implement neuro-thermodynamic computing and therefore may be said to be neuromorphic. For example, the neurons implemented using the oscillators of the thermodynamic chip may function as neurons of a neural network that has been implemented directly in hardware. Also, the thermodynamic chip is “thermodynamic” because the chip may be operated in the thermodynamic regime slightly above 0 Kelvin, wherein thermodynamic effects cannot be ignored. For example, some thermodynamic chips may be operated within the milli-Kelvin range, and/or at 2, 3, 4, etc. degrees Kelvin. The term thermodynamic chip also indicates that the thermal equilibrium dynamics of the neurons are used to perform computations. In some embodiments, temperatures less than 15 Kelvin may be used. Though other temperatures ranges are also contemplated. This also, in some contexts, may be referred to as analog stochastic computing. In some embodiments, the temperature regime and/or oscillation frequencies used to implement the thermodynamic chip may be engineered to achieve certain statistical results. For example, the temperature, friction (e.g., damping) and/or oscillation frequency as well as masses, may be controlled variables that ensure the oscillators evolve according to a given dynamical model, such as Langevin dynamics. In some embodiments, temperature may be adjusted to control a level of noise introduced into the evolution of the neurons. As yet another example, a thermodynamic chip may be used to model energy models that require a Boltzmann distribution. Also, a thermodynamic chip may be used to solve variational algorithms and perform learning tasks and operations.

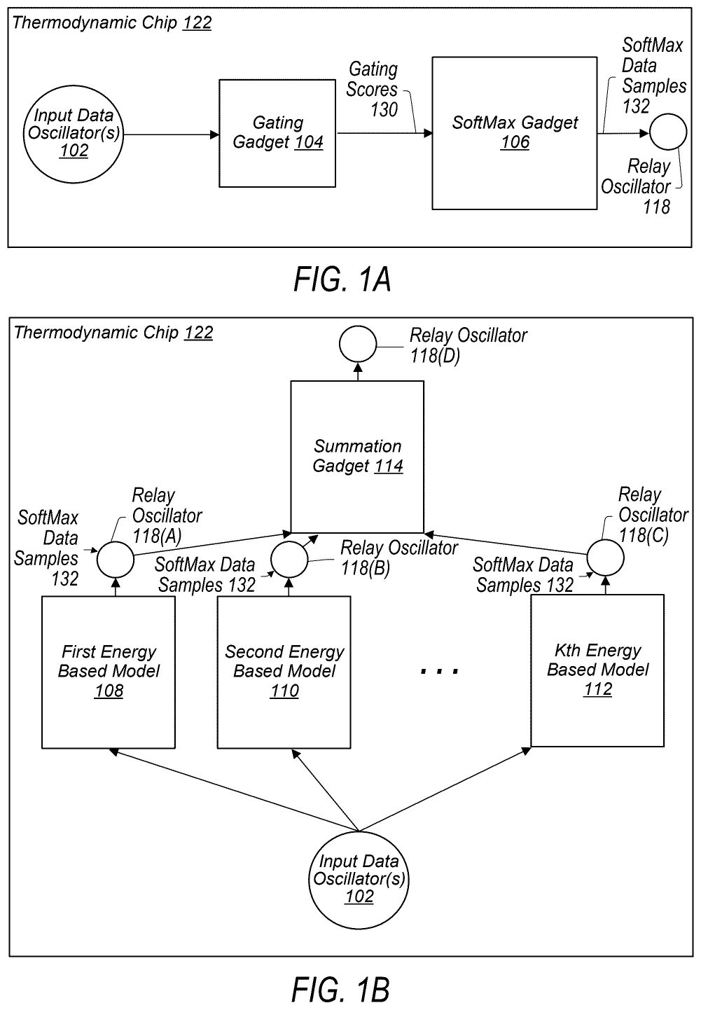

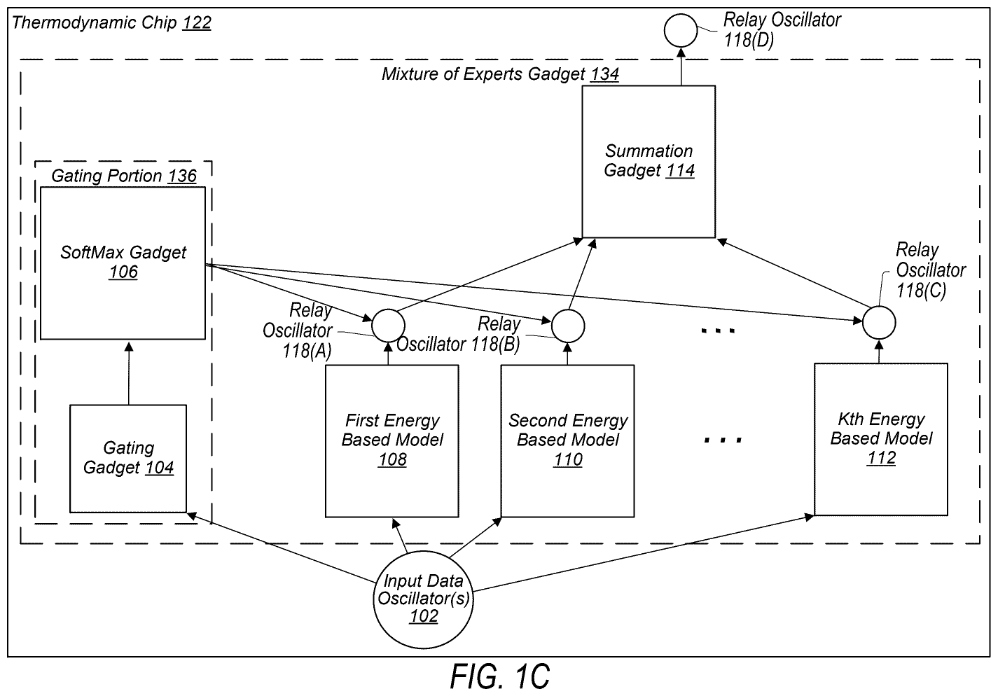

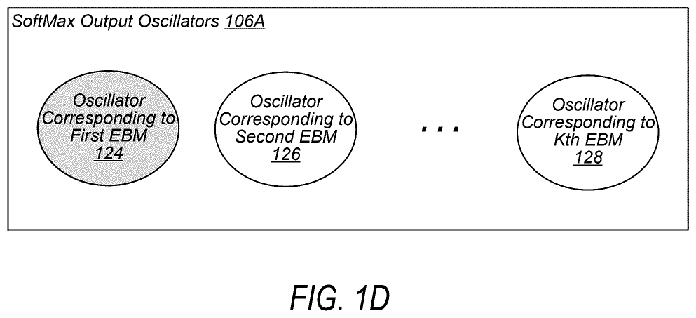

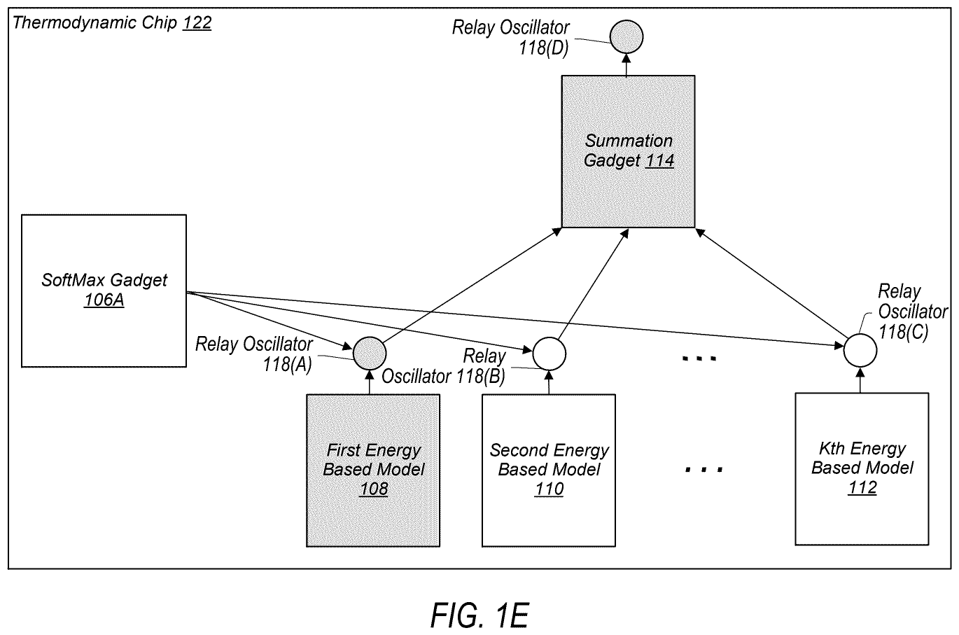

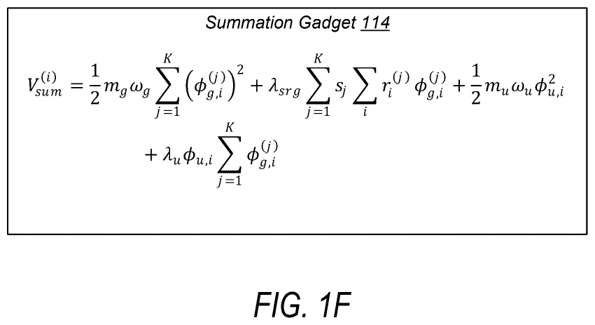

FIG. 1A is a high-level block diagram of a thermodynamic chip arrangement for a gating portion for a mixture of experts gadget, according to some embodiments.

A gating portion may be an EBM or a set of EBMs which select between expert EBMs based on input data. In FIG. 1A, the gating function for the mixture of experts gadget is performed by a SoftMax gadget 106, using input data which has been modified by a gating gadget 104. The output of the SoftMax gadget 106, and thus the gating portion for the mixture of experts model, may be a probability distribution corresponding to a set of experts, or a SoftMax data value, which may be a SoftMax data sample 132. For a set of K experts, given input vector x, output vector y may be represented as:

$$y = {\sum }_{i = 1}^{K} softmax {( G ( x ) )}_{i} {ε}_{{θ}_{i}} ( x )$$

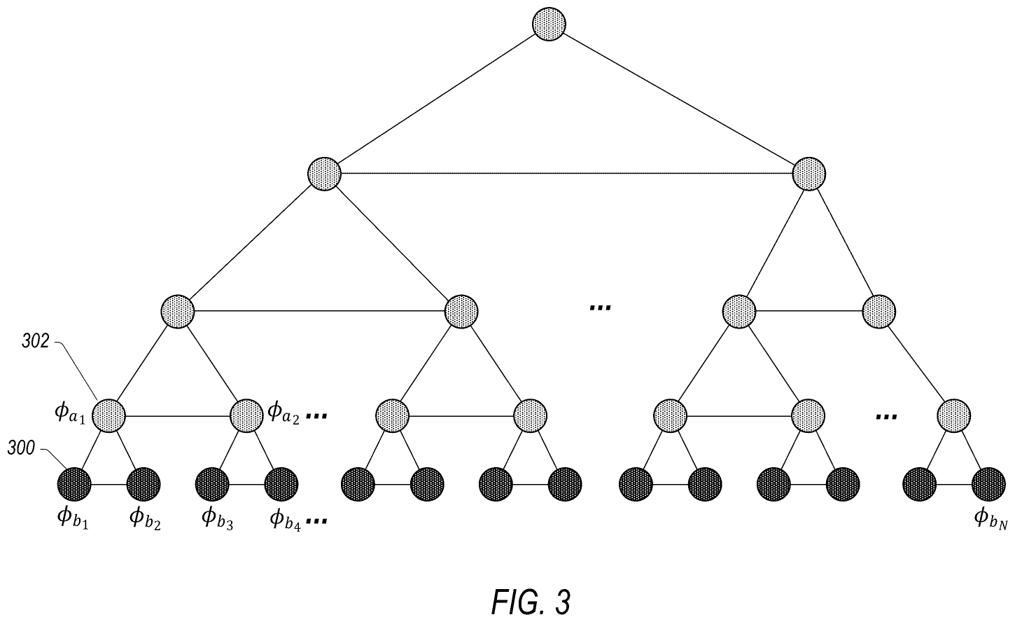

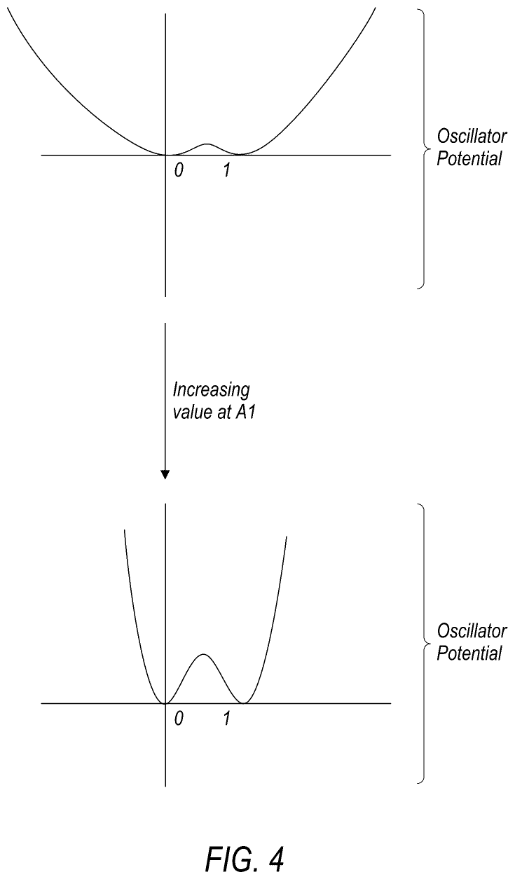

In the above equation, G represents a gating function implemented by gating gadget 104, θ represents EBMs, i represents a particular one of the expert EBMs, and ε_{θ}_{ᵢ} represents the potential energy for the ith expert EBM. The vectors x and y correspond to the position degrees of freedom encoded in a set of oscillators. A sample of data from a SoftMax gadget (132) may correspond to a one-hot encoded vector, meaning that a single dimension of the vector is approximately 1 and other dimensions of the vector are approximately 0. For example, <1,0,0>, <0,1,0>, and <0,0,1> are three-dimensional one-hot encoded vectors. In such embodiments, the SoftMax gadget 106 may be called a sparse gating network. In some embodiments, the SoftMax vectors may be averaged to a SoftMax value, so the output of the gating portion for the mixture of experts gadget would be a weighted average of several one-hot encoded vector samples. In such embodiments, the SoftMax gadget 106 may be called a dense gating network. Each dimension of the output vector from the gating portion corresponds to an expert EBM. An example SoftMax gadget 106 is further described at FIGS. 3-4.

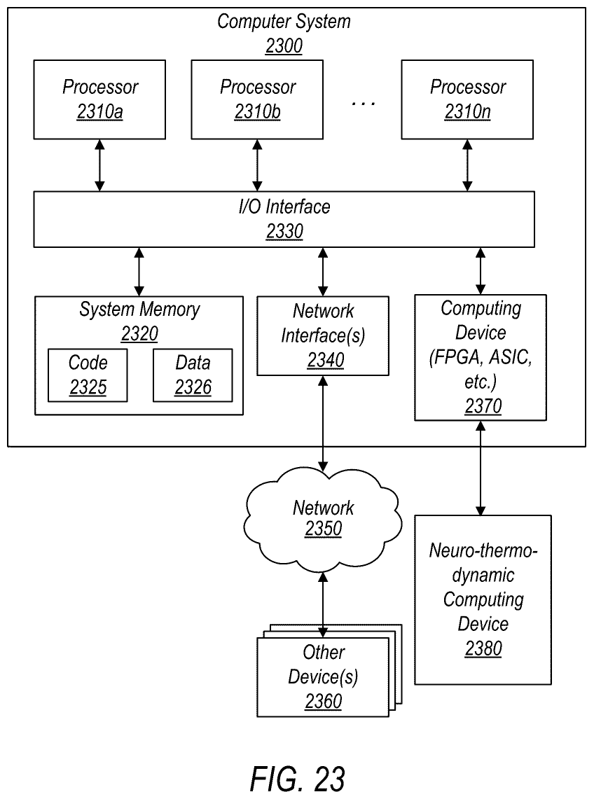

Input data oscillator(s) 102 may have been initialized with input data by a controller (such as a computing system similar to computing system 2300 illustrated in FIG. 23). Input data oscillator(s) 102 may be output oscillators of another EBM, and the input data stored in input data oscillator(s) 102 may have been generated by operation of another portion of the thermodynamic computer which uses the thermodynamic chip(s) 122. Data may be transferred from input data oscillator(s) 102 to gating gadget 104 and from gating gadget 104 to SoftMax gadget 106 using relay oscillators or relay gadgets (118). SoftMax data samples 132 generated by SoftMax gadget 106 may be held by one or more relay oscillators 118.

The gating gadget 104 may implement gating function G, which may generate modified input data or gating scores 130 for the respective expert EMBs based on the input data. Examples of gating functions may be G(x)=W_{g}x and G(x)=b·x where W_{g} is a matrix and b is a vector. The first example gating function may be implemented by a matrix multiplication gadget with a parameter matrix W_{g}. The second example gating function may be implemented by a bias parameter gadget, which has a bias parameter bⱼ, which corresponds to a given input oscillator out of j input oscillators. The data for a given input oscillator is multiplied by the corresponding b value. The output of the gating gadget 104 may be modified input data that the SoftMax gadget 106 may use as input to select an expert EBM. The parameters of the gating gadget 104 and the SoftMax gadget 106 may be set using a controller or learned via training. An example Hamiltonian for a matrix multiplication gadget is:

$$H = \frac{{ϕ}_{j}^{2}}{2 m} + \frac{1}{2} m {ωϕ}_{j}^{2} + λ {\sum }_{k {ϵε}_{j}} {W}_{k j} {ϕ}_{k} {ϕ}_{j}$$

FIG. 1B is a high-level block diagram of a thermodynamic chip arrangement for an output combination portion of the mixture of experts gadget, illustrated separately from a coupled gating portion, according to some embodiments.

The input data stored in input data oscillator(s) 102 may be transferred to the experts (i.e. first energy-based model 108, second energy-based model 110, and Kth energy-based model 112) directly or via a relay oscillator or relay gadget. The experts may process the input data and output the results to a set of output oscillators, which may be coupled to relay oscillators 118 (i.e., relay oscillators 118(A), 118(B), and 118(C)). The relay oscillators 118 (i.e., relay oscillators 118(A), 118(B), and 118(C)) may be coupled with output oscillators of the SoftMax gadget 106 to receive SoftMax data samples 132. The relay oscillators 118 (i.e., relay oscillators 118(A), 118(B), and 118(C)) may further be configured to couple to input oscillators of the summation gadget 114. The output of the summation gadget 114 may be stored in one or more relay oscillators 118(D).

FIG. 1C is a block diagram of a combination between the output combination portion of a mixture of experts gadget and the gating portion of the mixture of experts gadget, according to some embodiments.

While only one relay oscillator 118 per EBM is illustrated in FIG. 1C, each EBM may be associated with a number of relay oscillators 118 equal to the number of output oscillators of the EBM. The experts (i.e., first energy-based model 108, second energy-based model 110, and Kth energy-based model 112) may output vectors which have a number of dimensions i, the number being represented by L, so iϵ{1, . . . , L}. Accordingly, each expert may have L output oscillators and L relay oscillators 118. Summation gadget 114 may, for example, have L input oscillators, which may be coupled with corresponding ones of the relay oscillators 118 of the mixture of experts gadget 134 (i.e., relay oscillators 118(A), 118(B), and 118(C)). For example, a first (i.e. i=1) input oscillator of the summation gadget 114 may be coupled to a first (i.e., i=1) relay oscillator of the first energy-based model 108 (118(A)), a first (i.e., i=1) relay oscillator of the second energy-based model 110 (118(B), and a first (i.e., i=1) relay oscillator of the Kth energy-based model 112 (118(C). The relay oscillators 118 may be static relay oscillators or expectation value relay oscillators, as described below with respect to FIGS. 7A-12.

Each expert EMB may be associated with a particular j out of K EBMs, so jϵ{1, . . . , K}. Thus, the position degree of freedom of the output oscillators of the expert EBMs (i.e., first energy-based model 108, second energy-based model 110, and Kth energy-based model 112) may be represented as ϕᵣ^{(j)}, where j designates the associated expert EBM and r indicates that the oscillator is an output oscillator of the expert EBM. The position degree of freedom of the relay oscillators 118, may be represented as ϕ_{g}^{(j)}, where j designates the associated expert EBM and g indicates that the oscillator is a relay oscillator of the expert EBM.

The output oscillators for the SoftMax gadget 106. may have data samples which are a one-hot encoded vector which indicates a particular expert EBM or a SoftMax value vector which indicates weights for the expert EBMs. The output oscillators for the SoftMax gadget 106 may be relay oscillators or relay gadgets 118. The position degree of freedom of the oscillators with the SoftMax data samples may be represented as ϕₛ, which may also be represented as ϕₛ=S. s may represent the vector that is the output of the SoftMax gadget 106, and sⱼ may represent a particular dimension of s. The SoftMax gadget 106 and the gating gadget 104 may be part of a gating portion 136 of a mixture of experts gadget 134. In some embodiments, a gating gadget 104 may be trained with learnable parameters and a SoftMax gadget 106 may be kept with pre-set parameters to generate SoftMax data samples. In some embodiments both the gating gadget 104 and the SoftMax gadget 106 may be trained with learnable parameters to generate SoftMax data samples.

The coupling between a given expert EBMs (i.e., first energy-based model 108, second energy-based model 110, and Kth energy-based model 112), the corresponding relay oscillators 118, and the corresponding SoftMax output oscillators may be represented the following example potential:

$${V}_{s r g}^{( j )} = \frac{1}{2} {m}_{g} {ω}_{g} {\sum }_{i} {( {ϕ}_{g , i}^{( j )} )}^{2} + {λ}_{s r g} {s}_{j} {\sum }_{i} {r}_{i}^{( j )} {ϕ}_{g , i}^{( j )}$$

m_{g} represents the mass of the relay oscillators 118, and ω_{g} represents the frequency of the relay oscillators 118. i corresponds to the position degree of freedom for a particular oscillator out of the set of oscillators which make up each expert vector r^{(j)}. λ_{srg} is a coupling parameter and may be set using a controller. Continuing the example, the expectation value of the relay oscillators 118 is:

$$〈 {ϕ}_{g , i}^{( j )} 〉 = \frac{\int d {ϕ}_{g , i}^{( j )} {ϕ}_{g , i}^{( j )} {e}^{- β {V}_{srg}^{( j )}}}{\int d {ϕ}_{g , i}^{( j )} {e}^{- β {V}_{srg}^{( j )}}}$$

The above equation can be simplified to:

$$〈 {ϕ}_{g , i}^{( j )} 〉 = - \frac{{λ}_{s r g}}{{m}_{g} {ω}_{g}} {s}_{j} {r}_{i}^{( j )} .$$

Thus, if λ_{srg} is set to λ_{srg}=−m_{g}ω_{g} then expectation value for a given relay oscillator 118 will be [symbol] ϕ_{g,i}^{(j)} [symbol] =sⱼrᵢ^{(j)}, which is the expectation value for the corresponding expert EBM output oscillator multiplied by the expert EBM's weight output from the SoftMax gadget 106. The coupling strength between the input/output oscillators may be given by λ=−1/β, wherein β=1/K_{B}T, where K_{B} is the Boltzmann constant and T is temperature in Kelvin.

The summation gadget 114 finds the weighted sum of the output vectors from the expert EBMs. The summation gadget 114 has a set of input oscillators equal to the number of relay oscillators 118 (i.e., relay oscillators 118(A), 118(B), and 118(C)) corresponding to a single expert EBM (i.e., L). The position degrees of freedom for these L input oscillators may be represented as ϕ_{u,i}. For each i, the input oscillator, Qui, is coupled to all relay oscillators 118 (i.e., relay oscillators 118(A), 118(B), and 118(C)) of the corresponding vector dimension, ϕ_{g,i}^{(j)}. This coupling has the following example potential:

$${V}_{s u m}^{( t )} = \frac{1}{2} {m}_{g} {ω}_{g} {\sum }_{j = 1}^{K} {( {ϕ}_{g , i}^{( j )} )}^{2} + {λ}_{s r g} {\sum }_{j = 1}^{K} {s}_{j} {\sum }_{i} {r}_{i}^{( j )} {ϕ}_{g , i}^{( j )} + \frac{1}{2} {m}_{u} {ω}_{u} {ϕ}_{u , i}^{2} + {λ}_{u} {ϕ}_{u , i} {\sum }_{j = 1}^{K} {ϕ}_{g , i}^{( j )}$$

The above potential at equilibrium with λ_{srg}=−m_{g}ω_{g} as previous set is:

$$〈 {ϕ}_{u , i} 〉 = \frac{{m}_{g} {ω}_{g} {λ}_{u}}{2 {λ}_{u}^{2} - {m}_{g} {ω}_{g} {m}_{u} {ω}_{u}} {\sum }_{j = 1}^{K} {s}_{j} {r}_{i}^{( j )}$$

λᵤ is another coupling potential and may be set via the controller. Setting

$${λ}_{u} = \frac{1}{4} ( {m}_{g} {ω}_{g} \pm \sqrt{{m}_{g} {ω}_{g} ( {m}_{g} {ω}_{g} + 8 {m}_{u} {ω}_{u} )} )$$

causes the equilibrium value for the summation gadget 114 oscillators to be:

$$〈 {ϕ}_{u , i} 〉 = {\sum }_{j = 1}^{K} {r}_{i}^{( j )} {s}_{j}$$

The above equilibrium potential is the sum of the weighted output vectors from each expert EBM. The summation gadget 114 may couple to a set of relay oscillators or relay gadgets (118(D)) to output the equilibrium potential for readout by a controller or for use by another energy-based model of the thermodynamic computer.

FIG. 1D is a block diagram of a set of SoftMax output oscillators in a particular one-hot vector configuration which selects a particular energy-based model, according to some embodiments.

The configuration of the SoftMax output oscillators 106A shown in FIG. 1D can be represented by the one-hot encoded vector <1,0, . . . ,0>. The oscillator corresponding to the first expert EBM 124 has an approximate value of 1, encoded in the potential degree of freedom of the oscillator. The oscillator corresponding to the second expert EBM 126 and the oscillator corresponding to the Kth expert EBM both have a value of approximately 0, encoded in the potential degree of freedom of the oscillators. Unillustrated SoftMax output oscillators also have an approximate value of 0. The one-hot encoded vector <1,0, . . . ,0> selects the first expert EBM out of K expert EBMs.

FIG. 1E is the block diagram of the combination of the output combination portion of a mixture of experts gadget and the gating portion of the mixture of experts gadget with a selection of an energy-based model based on the one-hot vector of the SoftMax output oscillators, according to some embodiments.

The values of the example configuration of SoftMax output oscillators 106A from FIG. 1D, the one-hot encoded vector <1,0, . . . ,0>, can be used in combination with the equilibrium potentials described in association with FIG. 1C. The example configuration of SoftMax output oscillators 106A selects the first energy-based model 108 and the relay oscillator 118 associated with that expert EBM. The other expert EBMs (i.e., second energy-based model 110 and Kth energy-based model 112) are not selected. The summation gadget 114 obtains the output of the first-energy-based model 108 in substantially unchanged form, and may use the output of the first energy-based model 108 as the complete output of the summation gadget 114, which may be held in relay oscillator 118(D).

FIG. 1F is a block diagram of a configuration for a summation gadget which accepts results from a set of energy-based models based on a gating model such as a SoftMax gadget, according to some embodiments.

The example potential described above in relation to FIG. 1C,

$${V}_{s u m}^{( i )} = \frac{1}{2} {m}_{g} {ω}_{g} {\sum }_{j = 1}^{K} {( {ϕ}_{g , i}^{( j )} )}^{2} + {λ}_{s r g} {\sum }_{j = 1}^{K} {s}_{j} {\sum }_{i} {r}_{i}^{( j )} {ϕ}_{g , i}^{( j )} + \frac{1}{2} {m}_{u} {ω}_{u} {ϕ}_{u , i}^{2} + {λ}_{u} {ϕ}_{u , i} {\sum }_{j = 1}^{K} {ϕ}_{g , i}^{( j )} ,$$

describes the interactions between the oscillators at the coupling between the relay oscillators 118 and the input oscillators for the summation gadget 114. The potential causes the summation gadget 114 to perform the function of generating equilibrium potentials which are described by the equation: [symbol] ϕ_{u,i} [symbol] =Σⱼ₌₁^{K}rᵢ^{(j)}sⱼ. Generating equilibrium potentials which cause the oscillators of the summation gadget 114 to have position degrees of freedom which represent the sum of the weighted vectors produced by the expert EBMs is the mixture of experts function. These position degrees of freedom may be transferred to output oscillators or relay oscillators 118(D), or used or measured directly from the summation gadget 114.

Parameters of the mixture of experts system, which includes the summation gadget 114, the expert EBMs, the SoftMax gadget 106, and the gating gadget 104 can be trained using positive and negative phases. Parameter training may be represented by the following equation where t represents a particular training iteration:

$${θ}_{t + 1} = {θ}_{t} - \frac{{ϵ}_{t}}{2} N ( \frac{1}{n} {\sum }_{i = 1}^{n} {𝔼}_{z ∼ {p}_{{θ}_{t}} ( z \vert {x}_{{t}_{i}} )} [ {∇}_{{θ}_{t}} {ε}_{{θ}_{t}} ( {x}_{{t}_{i}} , z ) ] - {𝔼}_{( x , z ) \sim {p}_{{θ}_{t}} ( x , z )} [ {∇}_{{θ}_{t}} {ε}_{{θ}_{t}} ( x , z ) ] ) + {η}_{t}$$

The total energy of a system of EBMs can be represented as

$${ε}_{θ} = {\sum }_{a = 1}^{C} {ε}_{{B}_{a}}^{( {θ}_{{B}_{a}} )}$$

where θ_{B}_{ₐ} represents the particular EBM block Bₐ out of C total EBM blocks in the mixture of experts gadget system (i.e., a∈{1, . . . , C}) and ε represents energy. The total energy of the mixture of experts gadget system may be represented by the following example equation:

$${ε}_{θ} = {V}_{g} ( {ϕ}_{x} , {ϕ}_{z} ) + {V}_{s} ( {ϕ}_{z} , {ϕ}_{s} ) + {\sum }_{j = 1}^{K} {ε}_{{θ}_{j}} ( {ϕ}_{x} , {ϕ}_{{r}_{j}} ) + {\sum }_{i} {V}_{sum}^{( i )} ( {ϕ}_{g , i} , {ϕ}_{s} , {ϕ}_{{r}_{1}^{( i )}} , … , {ϕ}_{{r}_{K}^{( i )}} , {ϕ}_{u , i} )$$

In the above example equation, V_{G} represents the potential of the gating gadget 104, which may be a matrix multiplication gadget, a bias gadget, or another type of gadget. Vₛ represents the potential of the SoftMax gadget 106. ϕ_{z} represents the oscillators which transmit information from the gating gadget 104 to the SoftMax gadget 106. The total parameters to be trained are the parameters for the gating gadget 104 (i.e., W or b) and the parameters θ_{K} for the K expert EBMs. ϕₓ represents the input vector for the mixture of experts system and ϕᵤ represents the output vector for the mixture of experts system. The input and output oscillators may be clamped to data during training, or may be coupled to other EBM systems.

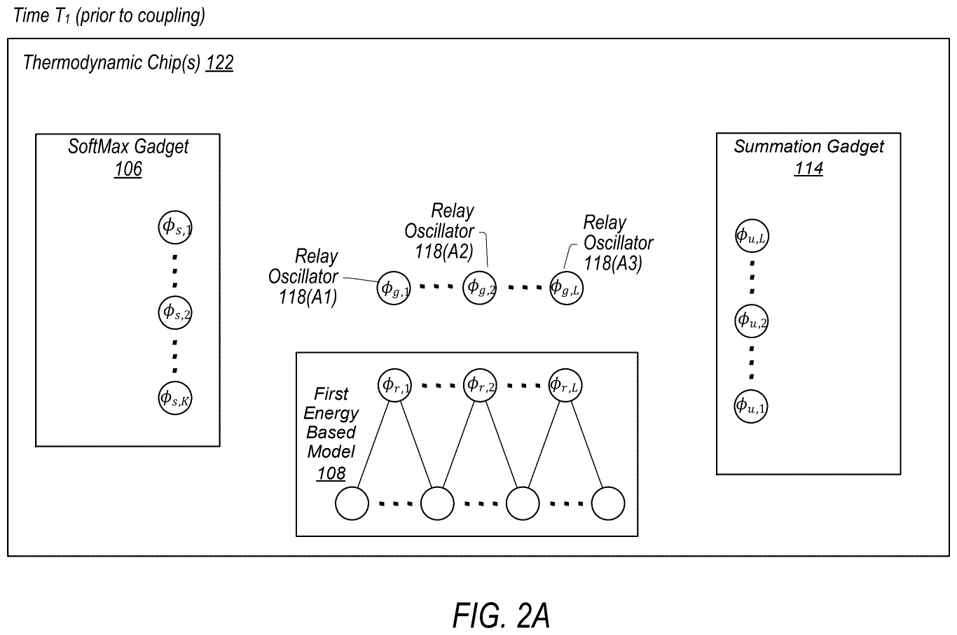

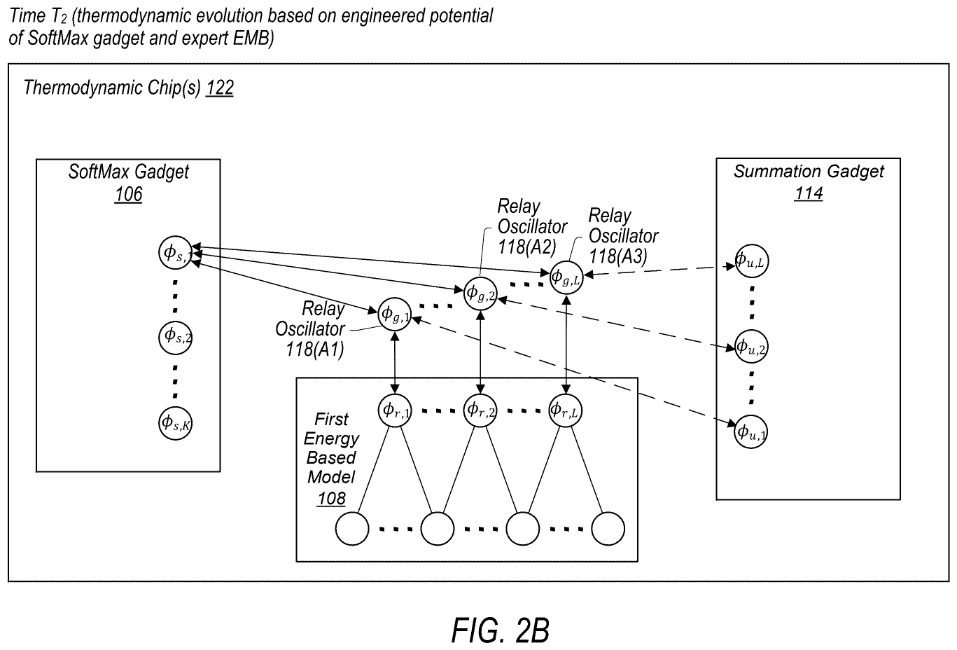

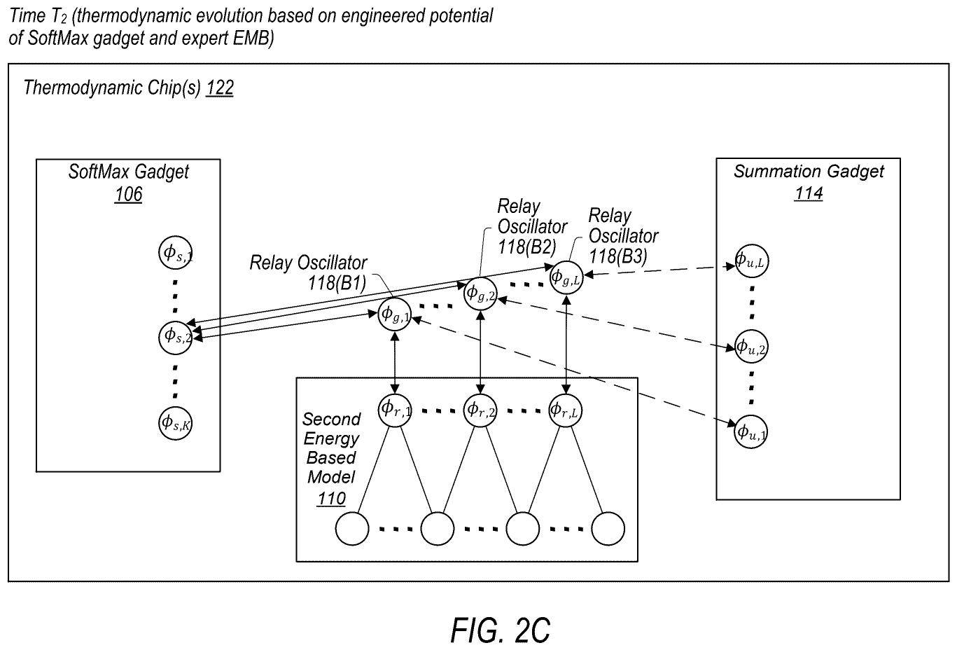

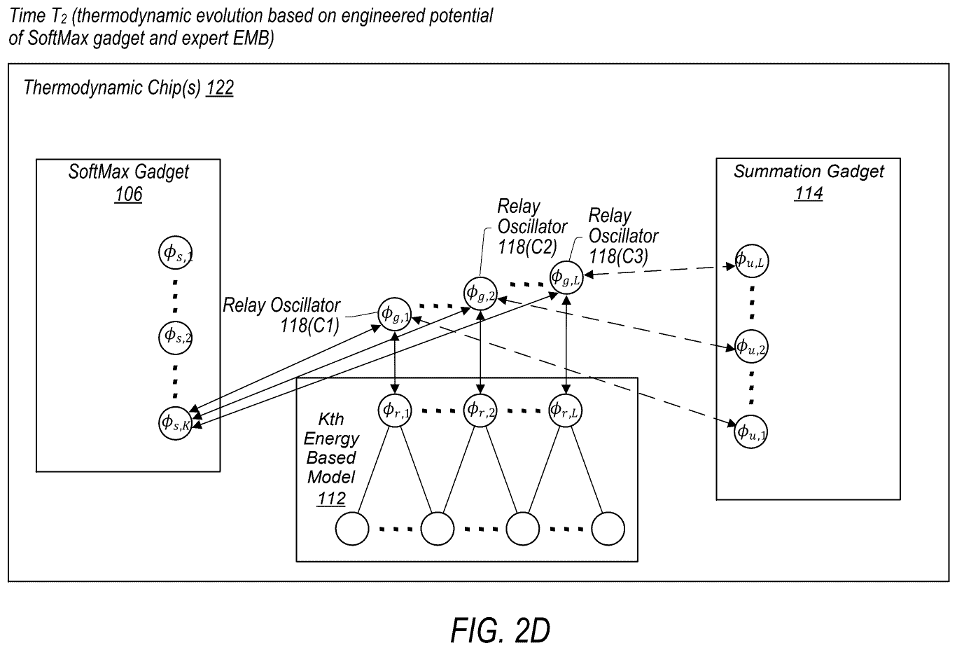

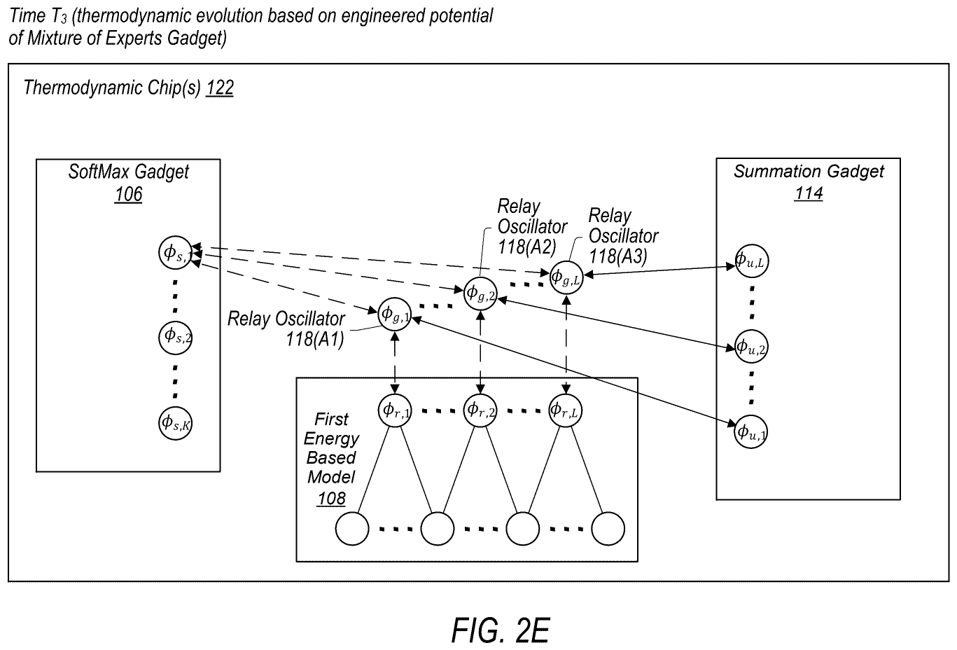

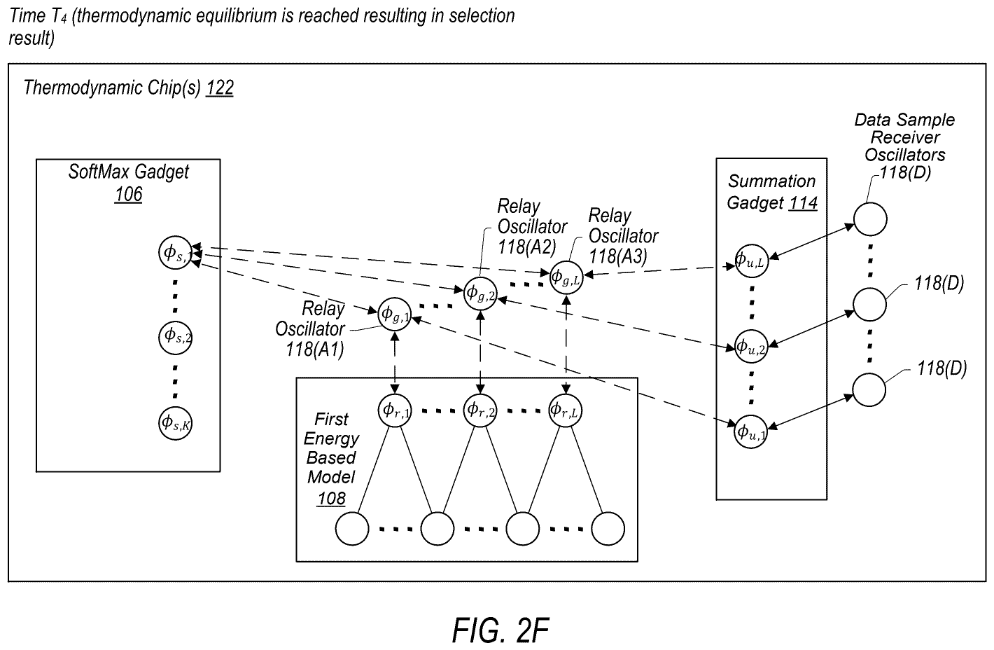

FIG. 2A is a block diagram of oscillators of a SoftMax gadget, a particular energy-based model, relay oscillators, and a summation gadget at a first time (T₁) such as prior to couplings between the oscillators being established, according to some embodiments.

FIG. 2A shows the oscillator components which interact with each other as illustrated in FIG. 1C. The SoftMax gadget 106 and summation gadget 114 may have additional oscillators which are not illustrated, and the first energy-based-model 108 is a representation of one possible EBM. The relay oscillators 118A may be static relay oscillators or expectation value oscillators, as described with respect to FIGS. 7A-12. The output oscillators of the SoftMax gadget 106 and expert EMB (i.e., first energy-based model 108) may be oscillators of the SoftMax gadget 106 and expert EMB or relay oscillators. Oscillators are described in further detail at FIGS. 19 and 20.

FIG. 2B is a block diagram of oscillators of the SoftMax gadget, a first particular energy-based model, the relay oscillators, and the summation gadget at a second time, such as after couplings between the output oscillators of the SoftMax gadget, the relay oscillators, and the output oscillators of the particular energy-based model are established and while thermodynamic evolution is occurring, according to some embodiments.

At time T₂, each relay oscillator 118A couples with the SoftMax output oscillator which corresponds to the expert EBM (i.e., first energy-based model 108) and with the expert EBM output oscillator that corresponds to the vector dimension of the relay oscillator 118A (i.e., the relay oscillator 118(A1) which has the position degrees of freedom designated as ϕ_{g,i} couples with the oscillator which has the position degrees of freedom designated as ϕ_{s,1} and also couples with the oscillator which has the position degrees of freedom designated as ϕ_{r,i}). This three-body coupling has the potential represented by the following equation as described with respect to FIG. 1C:

$${V}_{s r g}^{( j )} = \frac{1}{2} {m}_{g} {ω}_{g} {\sum }_{i} {( {ϕ}_{g , i}^{( j )} )}^{2} + {λ}_{s r g} {s}_{j} {\sum }_{i} {r}_{i}^{( j )} {ϕ}_{g , i}^{( j )}$$

At T₃, the mixture of experts input oscillator that corresponds to the vector dimension of the relay oscillator 118A will couple to the relay oscillator 118A (i.e., the oscillator which has the position degrees of freedom designated as ϕ_{g,i} couples with the oscillator which has the position degrees of freedom designated as ϕ_{u,i}). At time T₃, the input oscillators for the summation gadget 114 will be coupled with the relay oscillators 118 corresponding to the other expert EBMs. Thermodynamic evolution occurs based on the energetic potential between the oscillators with these couplings, as described in relation to FIG. 1C.

FIG. 2C is a block diagram of oscillators of the SoftMax gadget, a second particular energy-based model, the relay oscillators, and the summation gadget at the second time, such as after couplings between the output oscillators of the SoftMax gadget, the relay oscillators, and the output oscillators of the particular energy-based model are established and while thermodynamic evolution is occurring, according to some embodiments.

The corresponding SoftMax output oscillator for the second energy-based model 110 (i.e., the oscillator which has the position degrees of freedom designated as ϕ_{s,2}) couples with the relay oscillators 118B. The relay oscillators 118B are also coupled with the respective output oscillators of the expert EBM (i.e., the oscillator which has the position degrees of freedom designated as ϕ_{g,i} is coupled with the oscillator which has the position degrees of freedom designated as ϕ_{r,i}). This three-body coupling is similar to the three-body coupling described with respect to FIG. 2B.

FIG. 2D is a block diagram of oscillators of the SoftMax gadget, a third particular energy-based model, the relay oscillators, and the summation gadget at the second time, such as after couplings between the output oscillators of the SoftMax gadget, the relay oscillators, and the output oscillators of the particular energy-based model are established and while thermodynamic evolution is occurring, according to some embodiments.

The corresponding SoftMax output oscillator for the Kth energy-based model 112 (i.e., the oscillator which has the position degrees of freedom designated as ϕ_{s,K}) couples with the relay oscillators 118C. The relay oscillators 118C are also coupled with the respective output oscillators of the expert EBM (i.e., the oscillator which has the position degrees of freedom designated as ϕ_{g,i} is coupled with the oscillator which has the position degrees of freedom designated as ϕ_{r,i}). This three-body coupling is similar to the three-body coupling described with respect to FIG. 2B.

FIG. 2E is a block diagram of oscillators of the SoftMax gadget, a third particular energy-based model, the relay oscillators, and the mixture of experts gadget at a third time, such as after couplings between the relay oscillators and input oscillators of the mixture of experts gadget are established and while thermodynamic evolution is occurring, according to some embodiments.

At T₃, the mixture of experts input oscillator that corresponds to the vector dimension of the relay oscillator 118A couples to the relay oscillator 118A (i.e., the relay oscillator 118(A1) which has the position degrees of freedom designated as ϕ_{g,i} couples with the oscillator which has the position degrees of freedom designated as ϕ_{u,i}). At time T₃, the input oscillators for the summation gadget 114 may also couple with the relay oscillators 118 corresponding to the other expert EBMs. The engineered potential of the summation gadget 114 causes the oscillators of the summation gadget 114 to combine the outputs of the expert EMBs, as described with respect to FIG. 1F, into a vector that is weighted according to the SoftMax data sample at time T₂. Thermodynamic evolution occurs based on the energetic potential between the oscillators with these couplings, as described in relation to FIG. 1C.

FIG. 2F is a block diagram of oscillators of the SoftMax gadget, a first particular energy-based model, the relay oscillators, and the summation gadget at a fourth time, such as after thermodynamic equilibrium is reached and a set of data sample receiver oscillators 118(D), which may be relay oscillators, are able to take a data sample representing the expectation value vector from the mixture of experts gadget, according to some embodiments.

At time T₃, the mixture of experts system may have reached equilibrium potential, and data sampled from the summation gadget 114 may correspond to a vector which has been generated by the weighted combination of the output of the expert EBMs. The output oscillators of summation gadget 114 may couple to data sample receiver oscillators 118(D), which may be relay oscillators or relay gadgets. The data sample receiver oscillators 118(D) may store the data for read-out or use in another EBM.

FIG. 3 illustrates an example coupling for an analog SoftMax gadget, wherein ancilla oscillators (ϕₐ_{ⱼ}_{^{(l)}}) are used to emulate an all-to-all coupling between input/output oscillators (ϕ_{b}_{ⱼ}) of the analog SoftMax gadget, wherein the input/output oscillators (ϕ_{b}_{ⱼ}) and the additional oscillators (ϕₐ_{ⱼ}_{^{(l)}}) have a reduced degree of connectivity as compared to input/output oscillators (ϕ_{b}_{ⱼ}) used in an all-to-all coupling for a similar sized array of input/output oscillators, according to some embodiments.

In some embodiments, the input/output oscillators 300 of the analog SoftMax gadget 106 may be coupled to one another in an all-to-all coupling. The input/output oscillators 300 of the SoftMax gadget 106 may be relay oscillators, such as the oscillators 124, 126, and 128 illustrated in FIG. 1D. In configurations with a large number of input/output oscillators, such an all-to-all configuration may be cumbersome to implement. Thus, in some embodiments a constructive all-to-all coupling may be used, wherein additional ancilla oscillators are configured in a modified tree-structure to achieve a constructive all-to-all coupling between input/output oscillators 300. An example of a constructive all-to-all coupling is illustrated in FIG. 3.

For example, a binary tree type of lattice (e.g. modified tree) may be used to create similar constraints on the input/output oscillators 300 as an all-to-all coupling. Note that in the engineered potential used to implement the SoftMax function, e.g., V(ϕ_{b}_{₁}, . . . ,ϕ_{b}_{_{N}})=A₁Σⱼ₌₁^{N}ϕ_{b}_{ⱼ}²(ϕ_{b}_{ⱼ}−1)²+A₂(Σⱼ₌₁^{N}ϕ_{b}_{ⱼ}−1)², the A₂ constant that is proportional to the second term (e.g., after the plus sign) requires an all-to-all coupling. This is because expanding this term will result in a term proportional to Πⱼ₌₁^{N}ϕ_{b}_{ⱼ}However, in some embodiments, additional ancillary oscillators 302, as shown in FIG. 3, may be added to reduce the degree of connectivity required between individual ones of the oscillators. For example, for a vector of dimension N each individual oscillator may only require connectivity to four other oscillators as opposed to connectivity to all N-1 other ones of the input/output oscillators 300, as would be the case in a true all-to-all coupling.

For discussion purposes, the additional ancilla oscillators 302 can be considered to belong to a layer (l) and within each layer there are j ancilla oscillators 302. The layer that includes the root node (shown as ϕₐ_{₁} and ϕₐ_{₂}) in FIG. 3 may be referred to as layer 1, e.g. l=1. The next higher layer may be layer 2, e.g., l=2, and so on. A constraint is imposed on the ancilla oscillators 302 in the lowest layer (l=1) such that A₂⁽¹⁾(ϕₐ_{₁}⁽¹⁾−1)² for some large coupling parameter A₂⁽¹⁾. This imposes an energetic penalty if ϕₐ_{₁}⁽¹⁾ deviates from a value of 1. In a layer l the position degree of freedom of two sibling nodes, such as ϕₐ_{ⱼ}^{(l)} and ϕₐ_{ⱼ₊₁}^{(l)}, are further labeled with a subscript s to indicate they are sibling nodes. For example, they may be labeled as ϕₐ_{_{j,s}}^{(l)} and ϕₐ_{_{j+1,2}}^{(l)}. The set of siblings for a given layer above the first layer is [symbol] ^{(l)}. The position degree of freedom of a parent of a given set of sibling nodes is labeled as ϕₐ_{_{j,p}}^{(l-1)}. Using this notation, the potential can be written with an energy constraint, as follows:

$${V}_{A n c i l l a s} = {{A}_{2}^{( 1 )} ( {ϕ}_{{a}_{1}}^{( 1 )} - 1 )}^{2} + {\sum }_{l = 2}^{L - 1} {\sum }_{j ∈ {𝒮}^{( l )}} {{A}_{2}^{( l )} ( {ϕ}_{{a}_{j , s}}^{( l )} + {ϕ}_{{a}_{( j + 1 ) , s}}^{( l )} - {ϕ}_{{a}_{j , p}}^{( l - 1 )} )}^{2} + {\sum }_{j ∈ {𝒮}^{( L )}} {{A}_{2}^{( L )} ( {ϕ}_{a {b}_{j , s}}^{( L )} + {ϕ}_{{b}_{( j + 1 ) , s}}^{( L )} - {ϕ}_{{a}_{j , p}}^{( L - 1 )} )}^{2}$$

The above equation uses the fact that at the bottom of the tree (e.g., the oscillators below layer l=1), the oscillators corresponding to the leaf nodes are the original ϕ_{b}_{ⱼ} oscillators (e.g., the input/output oscillators 300). The above potential adds an energetic penalty in the root node for these leaf nodes (e.g., ϕₐ_{₁} and ϕₐ_{₂} as shown in FIG. 3) if the root node is not one. Additionally, an energetic penalty is added if the children of all of the root nodes do not sum to ϕₐ_{₁}⁽¹⁾, which should be 1. These conditions are added recursively until the leaf nodes are reached. The overall potential is then updated as:

$$V ( {ϕ}_{{b}_{1}} , … , {ϕ}_{{b}_{N}} ) = {A}_{1} {\sum }_{j = 1}^{N} {{ϕ}_{{b}_{j}}^{2} ( {ϕ}_{{b}_{j}} - 1 )}^{2} + {V}_{A n c i l l a s} .$$

FIG. 4 illustrates graphs of potentials for a given oscillator of the analog SoftMax gadget, wherein the given oscillator has a dual-well potential. FIG. 4 further illustrates how increasing the parameter A₁ in an engineered potential for the analog SoftMax gadget causes the walls and intermediate barrier between the two wells of the dual-well potential to be more steep, such that the dual-well oscillator is more likely to evolve to a value of 0 or 1 as required by the engineered potential for the analog SoftMax gadget, according to some embodiments.

The respective input/output oscillators 300 of the analog SoftMax gadget 106 may be implemented using dual-well potential oscillators. Furthermore, selecting an appropriate value for A₁ that is large creates an energetic penalty for values other than zero or one. This is illustrated in FIG. 4, wherein increasing the value of A₁ increases the well walls and the barrier between the wells, such that the minima of each of the wells is at zero or one.

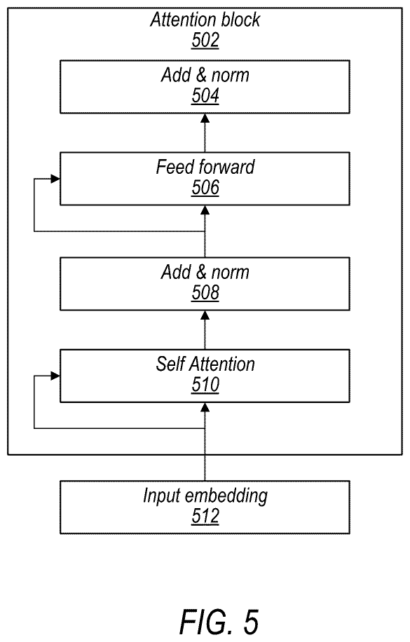

FIG. 5 illustrates an example attention block of a machine learning model, that may be implemented in an analog manner using one or more thermodynamic chips, wherein an analog Mixture of Experts gadget is used at least in part to implement an addition and normalization layer, according to some embodiments.

In some embodiments, an analog SoftMax gadget may be used as part of a thermodynamic implementation of a machine learning model. For example, in some embodiments a plurality of energy-based models may be used to implement functions of an attention block 502. For example, EBMs may be used to thermodynamically implement an Addition and Normalization layer 504, a Feed Forward layer 506, another Addition and Normalization layer 508, a Self-Attention layer 510, and Input Embedding 512. More specifically, an analog SoftMax gadget 106 may be one of a set of EBMs used to implement the Self-Attention layer 510. A Mixture of Experts gadget 114 may be one of a set of EBMs used to implement an Addition and Normalization layer 504 and 508.

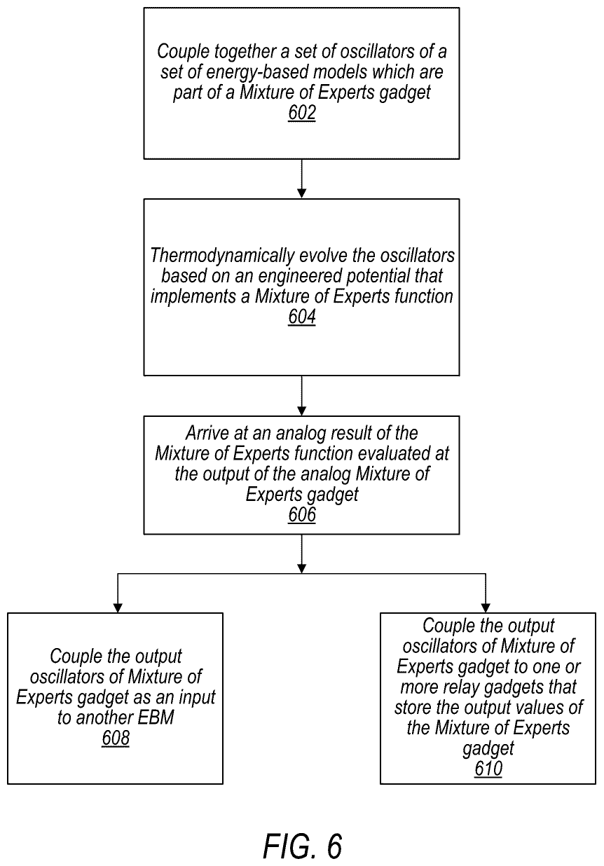

FIG. 6 is a flowchart illustrating a process for implementing a Mixture of Experts function using an analog SoftMax gadget, a set of energy-based models, and an analog summation gadget, according to some embodiments.

At block 602, a set of oscillators of a set of energy-based models which are part of a Mixture of Experts gadget (i.e., a gating gadget, a SoftMax gadget, a set of expert EBMs, and a summation gadget) are coupled together. Then, at block 604, the oscillators are allowed to thermally evolve, e.g. to reach a thermal equilibrium. This evolution is performed based on an engineered potential for the analog Mixture of Experts gadget which creates energetic penalties that drive the oscillators to thermodynamically evolve to a result based on the one-hot encoded vector state of the SoftMax gadget (e.g., one input/output oscillator of the SoftMax gadget having a position degree of freedom value of one, and all other input/output oscillators of the SoftMax gadget having a position degree of freedom value of zero, such that one output from the set of EMBs is selected and the non-selected outputs of other EMBs of the set of EBMs are suppressed). In some embodiments the SoftMax data samples may be SoftMax values which indicate a probability distribution for the expert EMBs.

At block 606 (after the thermal evolution) the input/output oscillators of the analog Mixture of Experts gadget arrive at an analog result of the Mixture of Experts function that comprises a result vector at the output oscillators of the analog Mixture of Experts gadget. In some embodiments, the result vector may be a result generated by a single selected EBM model. In some embodiments, the result vector may be based on repetitions of the oscillators reaching thermodynamic equilibrium, such as by sampling the output oscillators at various times and storing the results in a series of relay gadgets. The result vector may be a weighted result of the EBM models.

At block 608, the output oscillators of the analog Mixture of Experts gadget are coupled to another EBM or other device that is to receive the result of the Mixture of Experts function. This could be another EBM, relay oscillators, measurement, etc.

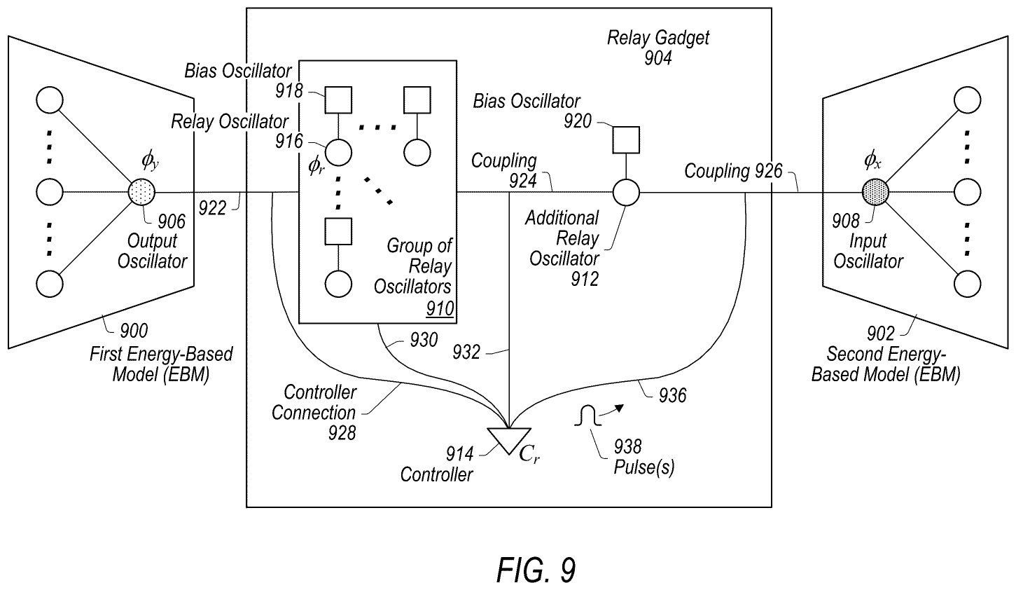

At block 610 the output oscillators of the analog Mixture of Experts gadget are coupled to relay gadgets, wherein the relay gadgets have any of the configurations shown in FIGS. 9-12. The relay gadgets store respective expectation values of the output oscillators of the analog Mixture of Experts gadget.

FIG. 7A is high-level diagram illustrating a first energy-based model (EBM) implemented using a thermodynamic chip, a second energy-based model (EBM) implemented using a thermodynamic chip, and a relay gadget implemented using a thermodynamic chip, wherein the relay gadget is configured to relay thermodynamic information between the first energy-based model (EBM) and the second energy-based model (EBM), according to some embodiments.

In some embodiments, a relay oscillator gadget, such as relay oscillator gadget 118, receives thermodynamic information from an input source, such as oscillator 706, and relays the thermodynamic information to an output destination, such as oscillator 708. In some embodiments, the oscillator 706 may be an output oscillator 706 of a first energy-based model (EBM) 700 and the oscillator 708 may be an input oscillator 708 of a second energy-based model (EBM) 702. In some embodiments, the thermodynamic information being relayed from the output oscillator 706 to the input oscillator 708 may be a position degree of freedom. As such, FIG. 7A shows an output position degree of freedom (ϕ_{y}) of the output oscillator 706 and an input position degree of freedom (ϕₓ) of the input oscillator 708, as well as a relay position degree of freedom (ϕᵣ) of the relay oscillator 718 and a bias position degree of freedom (ϕ_{b}) of the bias oscillator 712. Additionally, controller 714 is shown, which may be an on-chip controller. Controller 714 causes pulses to be emitted in a time dependent manner to orchestrate coupling of the relay oscillator 118 to the output oscillator 706, coupling of the relay oscillator 118 to the bias oscillator 712, adjustment of a mass or frequency of the relay oscillator 118, and a coupling of the relay oscillator 118 to the input oscillator 708. In some embodiments, the controller 714 may be pre-programmed to emit the relevant pulses and control signals in a time dependent sequence in order to execute a relay operation.

An example Hamiltonian of the coupled system shown in FIG. 7A is given by:

$${H}_{f a n} = \frac{{π}_{r}^{2}}{2 {m}_{r} ( t )} + \frac{{π}_{y}^{2}}{2 {m}_{y}} + \frac{{π}_{x}^{2}}{2 {m}_{x}} + \frac{{π}_{b}^{2}}{2 {m}_{b}} + \frac{1}{2} {m}_{r} ( t ) {ω}_{r}^{2} ( t ) {ϕ}_{r}^{2} + \frac{1}{2} {m}_{b} {ω}_{b}^{2} {ϕ}_{b}^{2} + \frac{1}{2} {m}_{y} {{ω}_{y}^{2} ( {ϕ}_{y} - {y}_{e} )}^{2} + \frac{1}{2} {m}_{x} {ω}_{x}^{2} {ϕ}_{x}^{2} + {λ}_{A} ( t ) {( {ϕ}_{y} - {ϕ}_{γ} )}^{2} + {λ}_{B} ( t ) {ϕ}_{b} {ϕ}_{r} + {λ}_{X} ( t ) {ϕ}_{r} {ϕ}_{X}$$

Note that the terms in the Hamiltonian including the λ_{A}, λ_{B}, and λ_{X} terms describe the coupling between the relay oscillators and the other three oscillators, e.g., the output oscillator 706, the bias oscillator 712, and the input oscillator 708. Also, note that all three coupling terms are time dependent, based on the λ_{A}, λ_{B}, and λ_{X} pulses controlled by controller 714. Additionally, note that the mass (or the frequency) of the relay oscillator 118 is time dependent, where the mass (or frequency) of the relay oscillator is also controlled by controller 714.

More particularly, the controller 714 emits pulses λ_{A} to couple the position degree of freedom (ϕ_{y}) of the output oscillator 706 to the position degree of freedom (ϕᵣ) of the relay oscillator 118. This coupling may remain turned on for some time. Then, once the coupling between the position degree of freedom (ϕ_{y}) of the output oscillator 706 and the position degree of freedom (ϕᵣ) of the relay oscillator 118 is turned off, the controller 714 causes pulses λ_{B} to be emitted to couple the position degree of freedom (ϕᵣ) of the relay oscillator 118 to the position degree of freedom (ϕ_{b}) of the bias oscillator 712, and simultaneously emits control signals to cause the mass of the relay oscillator 118 to be increased (or alternatively emits control signals to cause the oscillation frequency of the relay oscillator 118 to be tuned, for example decreased). When coupled to the relay oscillator 118, the bias position degree of freedom (ϕ_{b}) of the bias oscillator 712 acts as a bias to the relay oscillator 118 and helps to ensure that the relay position degree of freedom (ϕᵣ) of the relay oscillator 118 maintains its equilibrium value (that it has acquired from the output oscillator 706). After the relay oscillator 118 has reached an appropriately large mass (or tuned frequency), the controller 714 causes pulses λ_{X} to be emitted to couple the position degree of freedom (ϕᵣ) of the relay oscillator 118 (having the increased mass or tuned frequency) to the position degree of freedom (ϕ_{X}) of the input oscillator 708. Also, in some embodiments, the controller 714 may cause pulses λ_{X} and pulses λ_{B} to be emitted at the same time, such that the relay oscillator 118 is coupled to the bias oscillator 712 simultaneously with being coupled to the input oscillator 708. Note that in the illustration shown in FIG. 7A either of EBMs 700 or 702 may be an analog SoftMax gadget 106 or a Mixture of Experts gadget 114, that is to say the input to the relay oscillator may come from the analog SoftMax gadget 106 or the Mixture of Experts gadget 114, or the destination of the information being relayed may be the SoftMax gadget 106 or the Mixture of Experts gadget 114. FIG. 7A is illustrating a more general case for the relay gadget where the inputs and outputs are general EBMs, but it should be understood that the analog SoftMax gadget and the Mixture of Experts gadget are particular implementations of EBMs having an engineered potential that implements a function.

In some embodiments the following pulse shapes may be used for λ_{A}, λ_{B}, and λ_{X}. Though in some embodiments, other suitable pulse shapes may be used.

$${λ}_{A} ( t ) = {λ}_{A} ( σ ( {k}_{A} ( t - {t}_{1} ) ) - σ ( {k}_{A} ( t - {t}_{2} ) ) ) \\ {λ}_{B} ( t ) = - {λ}_{B} σ ( {k}_{B} ( t - {t}_{1}^{( B )} ) ) + {λ}_{0}^{( B )} \\ {λ}_{X} ( t ) = {λ}_{X} σ ( {k}_{X} ( t - {t}_{1}^{( X )} ) ) + {λ}_{0}^{( X )}$$

where σ(t) is the sigmoid function:

$$σ ( t ) = \frac{1}{1 + {e}^{- t}} .$$

In some embodiments, λ_{A}, λ_{B}, and λ_{X}, as well as k_{A}, k_{B}, and k_{X} may be tuned to improve results. Also, t₁, t₂, t₁^{(B)}, and t₁^{(X)} may be tuned.

Without loss of generality, the position degree of freedom of the output oscillator 706 (ϕ_{y}) is considered to have an equilibrium value (yₑ) (after energy-based model 700 has evolved for some time and reached a thermal equilibrium). Also, the position degree of freedom (ϕ_{y}) of the output oscillator 706 is considered to have a potential given by

$$\frac{1}{2} {m}_{y} {{ω}_{y}^{2} ( {ϕ}_{y} - {y}_{e} )}^{2} .$$

It should be noted in practice that the output oscillator 706 may be coupled to various other oscillators of the first energy-based model 700 (as shown in FIG. 7A) which would cause it to have the yₑ equilibrium value. Thus, to be more comprehensive,

$$\frac{1}{2} {m}_{y} {{ω}_{y}^{2} ( {ϕ}_{y} - {y}_{e} )}^{2}$$

may be replaced by a potential term that takes into account these couplings, such as

$$\frac{1}{2} {m}_{y} {{ω}_{y}^{2} ( {ϕ}_{y} - {y}_{e} )}^{2} + {\sum }_{j} {λ}_{Y}^{( j )} {φ}_{y} {φ}_{j} or$$

$$\frac{1}{2} {m}_{y} {{ω}_{y}^{2} ( {φ}_{y} - {y}_{e} )}^{2} + {λ}_{Y} {\sum }_{j} {{λ}_{Y}^{0 )} ( {φ}_{y} - {φ}_{j} )}^{2} ,$$

where the ϕⱼ degrees of freedom are degrees of freedom of other oscillators in the first energy-based model 700 that are coupled to the position degree of freedom (ϕ_{y}) of the output oscillator 706. However, this difference (or said another way, simplification) manifests itself in a slightly different value for the equilibrium value (yₑ), or depending on the couplings, may result in the same yₑ equilibrium value. But this simplification does not affect the equilibrium results of the relay oscillator 118. A similar issue applies to the input oscillator 708, which is also coupled to other oscillators of the second energy-based model 702. Also, in some embodiments, multiple relay oscillators 710 may be coupled to multiple input oscillators (e.g. additional input oscillators in addition to input oscillator 708). Note that the relay oscillator 118 and the relay gadget 704 impart the equilibrium value of the output oscillator to the input oscillator, such that the position degree of freedom (ϕₓ) of the input oscillator 708 inherits the same equilibrium value as the position degree of freedom (ϕ_{y}) of the output oscillator 706, e.g. the position it had when first coupled to the relay oscillator 118 of the relay gadget 704. As such, thermodynamic information is relayed from the output oscillator 706 to the input oscillator 708 while remaining in a thermodynamic state. For example, analog information is passed between the first energy-based model 700 and the second energy-based model 702 without requiring a measurement by a classical computing device. Further note, this is done in an analog way (as opposed to a digitization that would take place during readout and re-initialization).

For a system undergoing Langevin dynamics, the equation of motion of a given oscillator (k) is given by:

$$\frac{d {ϕ}_{k} ( t )}{dt} = \frac{\partial {H}_{fan}}{\partial {π}_{k}} \\ \frac{{π}_{k} ( t )}{dt} = - γ {π}_{k} ( t ) - \frac{\partial {H}_{fan}}{\partial {ϕ}_{k}} {\vert}_{t} + \sqrt{2 {m}_{k} γ {k}_{B} T} \frac{{dW}_{t}}{dt}$$

where ϕ denotes the position degree of freedom of the oscillator and I denotes the momentum degree of freedom of the oscillator. Using the Hamiltonian for the coupled system shown in FIG. 7A (which is given further above) and the equations of motion for position and momentum given directly above, the equations of motions for the relay oscillator 118, output oscillator 106, the bias oscillator 712, and the input oscillator 708, are respectively given by:

### Equation of Motion for the Relay Oscillator

$${m}_{r} ( t ) \frac{{d}^{2} {ϕ}_{r}}{{dt}^{2}} + \frac{d {m}_{r} ( t )}{dt} \frac{d {ϕ}_{r}}{dt} + γ {m}_{r} ( t ) \frac{d {ϕ}_{r}}{dt} = - ( - 2 {λ}_{A} ( t ) ( {ϕ}_{y} - {ϕ}_{r} ) + {λ}_{B} ( t ) {ϕ}_{b} + {λ}_{X} ( t ) {ϕ}_{x} + {m}_{r} ( t ) {ω}_{r}^{2} {ϕ}_{r} ) + \sqrt{2 {m}_{r} ( t ) {k}_{B} T} \frac{d {W}_{t}^{( r )}}{dt}$$

$$Or$$

$${m}_{r} ( t ) \frac{{d}^{2} {ϕ}_{r}}{{dt}^{2}} + \frac{d {m}_{r} ( t )}{dt} \frac{d {ϕ}_{r}}{dt} + γ {m}_{r} ( t ) \frac{d {ϕ}_{r}}{dt} = - ( - 2 {λ}_{A} ( t ) ( {ϕ}_{y} - {ϕ}_{r} ) - 2 {λ}_{B} ( t ) ( {ϕ}_{b} - {ϕ}_{r} ) + 2 {λ}_{X} ( t ) ( {ϕ}_{r} - {ϕ}_{x} ) + {m}_{r} ( t ) {ω}_{r}^{2} {ϕ}_{r} ) + \sqrt{2 {m}_{r} ( t ) {k}_{B} T} \frac{d {W}_{t}^{( r )}}{dt}$$

Depending on whether there is a linear or quadratic coupling.

### Equation of Motion for the Output Oscillator

$${m}_{y} \frac{{d}^{2} {ϕ}_{y}}{{dt}^{2}} + γ {m}_{y} \frac{d {ϕ}_{y}}{dt} = - ( {λ}_{A} ( t ) {ϕ}_{y} + {m}_{y} {ω}_{y}^{2} ( {ϕ}_{y} - {ϕ}_{c} ) ) + \sqrt{2 {m}_{y} {k}_{B} T} \frac{d {W}_{t}^{( y )}}{dt} \\ Or \\ {m}_{y} \frac{{d}^{2} {ϕ}_{y}}{{dt}^{2}} + γ {m}_{y} \frac{d {ϕ}_{y}}{dt} = - ( 2 {λ}_{A} ( t ) ( {ϕ}_{y} - {ϕ}_{r} ) + {m}_{y} {ω}_{y}^{2} ( {ϕ}_{y} - {ϕ}_{c} ) ) + \sqrt{2 {m}_{y} {k}_{B} T} \frac{d {W}_{t}^{( y )}}{dt}$$

Depending on whether there is a linear or quadratic coupling.

### Equation of Motion for the Bias Oscillator

$${m}_{b} \frac{{d}^{2} {ϕ}_{b}}{{dt}^{2}} + γ {m}_{b} \frac{d {ϕ}_{b}}{dt} = - ( {λ}_{B} ( t ) {ϕ}_{r} + {m}_{b} {ω}_{b}^{2} {ϕ}_{b} ) + \sqrt{2 {m}_{b} {k}_{B} T} \frac{d {W}_{t}^{( b )}}{dt}$$

$$Or$$

$${m}_{b} \frac{{d}^{2} {ϕ}_{b}}{{dt}^{2}} + γ {m}_{b} \frac{d {ϕ}_{b}}{dt} = - ( - 2 {λ}_{B} ( t ) ( {ϕ}_{r} - {ϕ}_{b} ) + {m}_{b} {ω}_{b}^{2} {ϕ}_{b} ) + \sqrt{2 {m}_{b} {k}_{B} T} \frac{d {W}_{t}^{( b )}}{dt}$$

Depending on whether there is a linear or quadratic coupling.

### Equation of Motion for the Input Oscillator

$${m}_{x} \frac{{d}^{2} {ϕ}_{x}}{{dt}^{2}} + γ {m}_{x} \frac{d {ϕ}_{x}}{dt} = - ( {λ}_{X} ( t ) {ϕ}_{r} + {m}_{x} {ω}_{x}^{2} {ϕ}_{x} ) + \sqrt{2 {m}_{x} {k}_{B} T} \frac{d {W}_{t}^{( x )}}{dt} \\ Or \\ {m}_{x} \frac{{d}^{2} {ϕ}_{x}}{{dt}^{2}} + γ {m}_{x} \frac{d {ϕ}_{x}}{dt} = - ( - 2 {λ}_{X} ( t ) ( {ϕ}_{r} - {ϕ}_{x} ) + {m}_{x} {ω}_{x}^{2} {ϕ}_{x} ) + \sqrt{2 {m}_{x} {k}_{B} T} \frac{d {W}_{t}^{( x )}}{dt}$$

Depending on whether there is a linear or quadratic coupling.

Also, the time dependent mass of the relay oscillator 110 is given by:

$${m}_{r} ( t ) = {m}_{f}^{( r )} σ ( {k}_{r} ( t - {t}_{r} ) ) + {m}_{r} .$$

FIG. 7B is a high-level diagram similar to FIG. 7A, wherein the relay gadget does not include a bias oscillator, according to some embodiments.

In some embodiments, such as when the relay oscillator is configured to have a controllable time-dependent mass, the use of a bias oscillator may be omitted. For example, if the product of mass times frequency squared of a first oscillator is much larger than the product of mass times frequency of a second oscillator (that is coupled to the first oscillator) the position degree of freedom of the first oscillator (having the larger value for the product of mass times frequency squared) may be treated as a constant. Thus, for embodiments, wherein the mass of the relay oscillator can be increased such that the product of mass times frequency squared of the relay oscillator is sufficiently large, it may not be necessary to further use a bias oscillator.

More particularly, consider two oscillators (oscillator a and oscillator b) with position degrees of freedom ϕₐ and ϕ_{b}. Suppose that ϕ_{b} has equilibrium value b_{c}. Assume ϕ_{b} is a constant and consider the Hamiltonian:

$${H}_{1} = \frac{1}{2} {m}_{a} {ω}_{a}^{2} {ϕ}_{a}^{2} + λ {ϕ}_{a} {b}_{c}$$

In this case, the expectation value of Pa at thermal equilibrium is given by:

$$〈 {ϕ}_{a} 〉 = \frac{\int {ae}^{- β {H}_{1}} da}{\int {e}^{- β {H}_{1}} da} = \frac{λ {b}_{c}}{{m}_{a} {ω}_{a}^{2}} \\ Choosing λ = - {m}_{a} {ω}_{a}^{2} , it gives 〈 {ϕ}_{a} 〉 = {b}_{c} .$$

Also, considering the dynamics of ϕ_{b}. The Hamiltonian is:

$${H}_{2} = \frac{1}{2} {m}_{a} {ω}_{a}^{2} {ϕ}_{a}^{2} + \frac{1}{2} {m}_{b} {{ω}_{b}^{2} ( {ϕ}_{b} - {b}_{c} )}^{2} + λ {ϕ}_{a} {ϕ}_{b}$$

Moreover, using H₂, [symbol] ϕₐ [symbol] is given by:

$$〈 {φ}_{a} 〉 = \frac{\int {ae}^{- β {H}_{2}} da db}{\int {e}^{- β {H}_{2}} da db} = \frac{λ {b}_{c}}{{m}_{a} {ω}_{a}^{2} - \frac{{λ}^{2}}{{m}_{b} {ω}_{b}^{2}}} = \frac{{b}_{c}}{1 - \frac{{m}_{a} {ω}_{a}^{2}}{{m}_{b} {ω}_{b}^{2}}}$$

where λ is set such that λ=−mₐωₐ². Note that if mₐωₐ². <<m_{b}ω_{b}², then [symbol] ϕₐ [symbol] ≈b_{c}. As such as long as the mass times frequency squared of the oscillator a having position degree of freedom ϕₐ is much less than the mass times frequency squared of the oscillator b having position degree of freedom ϕ_{b}, the position degree of freedom ϕ_{b} can be treated as a constant, with the constant being the thermal equilibrium value of ϕ_{b}.

Said another way, if the product of mass times frequency squared of the relay oscillator 118 is increased to be sufficiently large, then the inherited equilibrium value acquired from the output oscillator 706 can be treated as a constant, while held by the relay oscillator 118. Also, as long as the product of mass times frequency squared of the relay oscillator 118 is sufficiently large as compared to the corresponding value of mass times frequency squared of the input oscillator 708, the position degree of freedom of the relay oscillator may be treated as a constant, such that it relays the held equilibrium value acquired from the output oscillator 706 of the first EBM 700 to the input oscillator 708 of the second EBM 702.

Note that the relay oscillators used in the relay gadget configurations shown in FIGS. 9-12, include bias oscillators. However, in some embodiments, similar configurations may be used that do not include bias oscillators. For example, relay oscillators as shown in FIG. 7A or as shown in FIG. 7B may be used to construct the relay gadgets shown in FIGS. 9-12.

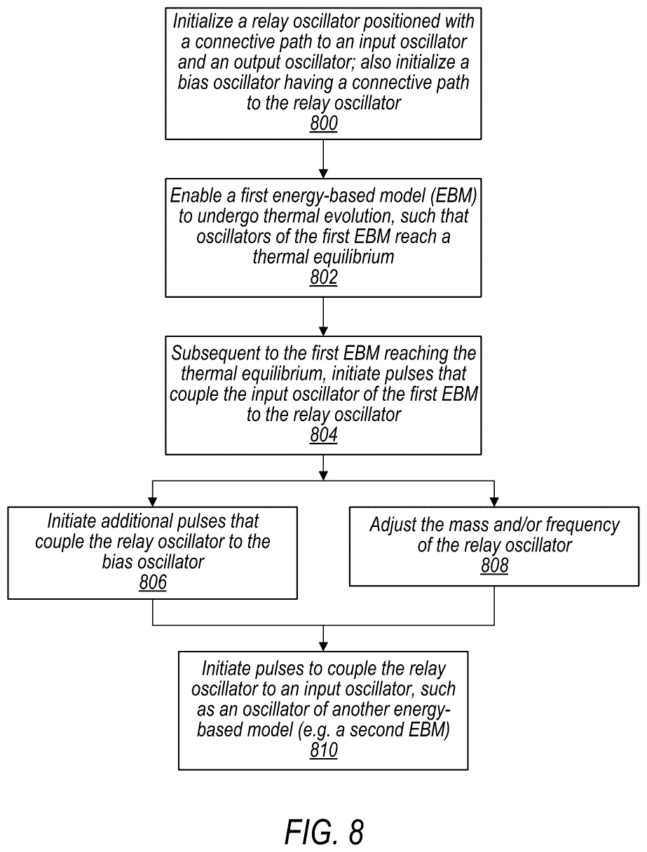

FIG. 8 is a high-level flowchart illustrating a process of relaying thermodynamic information between an output oscillator, such as of a first energy-based model (EBM), and an input oscillator, such as of a second energy-based model (EBM), according to some embodiments.

At block 800 a relay oscillator is initialized, wherein the relay oscillator is positioned such that it has connectivity to an output oscillator, such as output oscillator 706 of energy-based model 700, and has connectivity to an input oscillator, such as input oscillator 708 of energy-based model 702. Additionally, a bias oscillator is initialized, wherein the bias oscillator has connectivity to the relay oscillator. For example, bias oscillator 712 may be initialized and is positioned in a way that it can be coupled to relay oscillator 118.

At block 802, the first energy-based model comprising the output oscillator, such as energy-based model 700 that includes output oscillator 706, is enabled to undergo thermal evolution such that the energy-based model evolves according to Langevin dynamics. The evolution may be enabled to occur for an amount of time such that the first energy-based model reaches a thermal equilibrium. As an example, the first energy-based model may represent a trained model that is configured to perform inference, and at least some oscillators of the first energy-based model may be clamped to input data, wherein inference results are represented by other oscillators of the first energy-based model subsequent to the thermal evolution. For example, output oscillator 706 may represent the results of a computation performed by the energy-based model 700 that are to be relayed as input data to the second energy-based model 702.

At block 804, once the oscillators of the first energy-based model (e.g. energy-based model 700) have reached thermal equilibrium, the controller 714 initiates pulses (e.g. λ_{A}(t) pulses) to cause the output oscillator 706 to be coupled to the relay oscillator (e.g. relay oscillator 118).

At block 806, the controller 714 initiates additional pulses (e.g., λ_{B}(t) pulses) that cause the relay oscillator to be coupled to the bias oscillator. Recall that initially the relay oscillator 118 may have a small mass and/or frequency combination, e.g., small relative to the product of mass times frequency squared of the output oscillator 706. Because the relay oscillator has a small product of mass times frequency squared, the relay oscillator more readily takes on the position of the output oscillator (for example, as opposed to the relay oscillator pulling the output oscillator to take on the relay oscillator's position). However, due to the relatively small mass times frequency squared of the relay oscillator, if left alone the relay oscillator would quickly lose the recently inherited position, inherited from the output oscillator. To avoid this, the relay oscillator is coupled to the bias oscillator 712 at or near the same time as the relay oscillator is un-coupled from the output oscillator 706. The relay oscillator may also be coupled to the bias oscillator at or near the same time it is coupled to the input oscillator 708. Coupling the relay oscillator to the bias oscillator helps the relay oscillator to maintain the acquired thermal information (e.g., position degree of freedom, or, in some embodiments, momentum degree of freedom) the relay oscillator has acquired from the output oscillator. Also, while coupled to the bias oscillator and prior to being coupled to the input oscillator of the next EBM, a mass and/or frequency of the relay oscillator is adjusted.

For example, at block 808, the controller 714 causes control signals to be emitted that cause the mass (or frequency) of the relay oscillator to be adjusted. The mass of the relay oscillator may be proportional to capacitance of a circuit used to implement the relay oscillator; a Cooper-pair box arrangement may be used to implement a time dependent capacitance in the circuit (e.g. where the capacitance corresponds to mass). In such embodiments, the controller 714 is configured to emit control signals to cause the Cooper-pair box to increase the capacitance of the relay oscillator circuit. However, in other embodiments, mass may be kept constant, but instead frequency of the relay oscillator may be adjustable as a result of a time-dependent flux element of a circuit used to implement the relay oscillator. For example, a current inducing flux element may be added to the relay oscillator circuit. In such embodiments, controller 714 may emit control signals that cause the flux of the relay oscillator to be tuned (where flux corresponds to frequency). In some embodiments blocks 806 and 808 are performed concurrently.

At block 810, the controller 714 initiates another set of one or more pulses (e.g., λ_{X}(t) pulses) to couple the relay oscillator to the input oscillator, such as input oscillator 708. The bias oscillator 712 may remain coupled to the relay oscillator 118 when the relay oscillator 118 is coupled to the input oscillator 708. Note that since the relay oscillator has had its mass (and/or frequency) adjusted prior to the coupling to the input oscillator, and since the relay oscillator remains coupled to the bias oscillator, the relay oscillator has a large value of the product of mass times frequency squared relative to the input oscillator and therefore causes the input oscillator to take on the position of the relay oscillator, which corresponds to the position of the output oscillator. In this way, the relay gadget 704 relays analog oscillator degree of freedom information (e.g. thermodynamic information) from the output oscillator to the input oscillator, without having to convert the thermodynamic information into classical form.

In some embodiments, a relay gadget, such as relay gadget 704, may perform steps similar to those described in FIG. 8 in order to relay position degree of freedom thermodynamic information, momentum degree of freedom thermodynamic information, and/or force/acceleration degree of freedom thermodynamic information.

In some embodiments, a relay gadget, such as relay gadget 704 may be used to store thermodynamic information, for example in the relay oscillator 118. Also, in some embodiments, multiple relay gadgets may be used to form a thermodynamic network between thermodynamic components. Also, in some embodiments, a relay gadget may be used to perform conditional sampling, such as Gibbs sampling.

FIG. 9 is a high-level diagram illustrating an output oscillator, an input oscillator, and a relay gadget, wherein the relay gadget comprises a group of relay oscillators and is configured to relay expectation values of thermodynamic information between the output oscillator and the input oscillator, according to some embodiments.

In some embodiments, it is desired to transfer an expectation value of one energy-based model (EBM) to another EBM, such as from an output of analog SoftMax gadget 106 to an input of another EBM, such as a Mixture of Experts gadget 114. In some embodiments an instantaneous sample value may be transferred from an output oscillator of one EBM (such as from a given input/output oscillator 300 of analog SoftMax gadget 106) to an input oscillator of another EBM (such as to an input oscillator of an analog Mixture of Experts gadget 114). The instantaneous sample value of an output oscillator of a given EBM will follow a probability distribution associated with the potential well of the output oscillator and couplings of the output oscillator with the one or more oscillators belonging to the first EBM. An instantaneous sample value of the state of the output oscillator may be any possible value within the bounds of the potential well and respective couplings. In some instances, the instantaneous sample value of the output oscillator may be far off from the expectation value (e.g. due to thermodynamic fluctuations, anharmonic potentials, multiple well potentials, the coupling between the output oscillator with other oscillators belonging to a shared EBM, or a combination of factors). Furthermore, the output oscillator of an EBM may hop between wells of a potential, thus the expectation value may not be a probable outcome of an instantaneous sample of the output oscillator. To avoid these issues, in some embodiments expectation values may be stored instead of sample values and relayed as inputs to other EBMs.

In some embodiments, to enable an expectation value of an output of an EBM to be used as an input to a subsequent EBM in a fully analogue fashion (e.g. without the use of measurements), two or more relay oscillators may be used. In some embodiments, an expectation value is derivable from one or more sample values. In some embodiments, relay oscillators may be oscillators which may be arranged between the output of a given EBM and the input of an additional EBM in such a way that their state may be configured to take on a sample value of the output oscillators of a given EBM. In some embodiments, sample values may be collected in such a way (e.g. spatial or temporal arrangement of relay oscillators as described below) that a close approximation of an expectation value of an output of a given EBM may be represented on one or more relay oscillators. Classical controllers may be used to turn the couplings on and off between the output oscillators and relay oscillators, between respective relay oscillators, as well as to make the masses and frequencies of the relay oscillators time dependent. Nevertheless, measurements may not be required, and the timing of the operations may be computed during a compilation step.

In some embodiments, a relay gadget may include a group of one or more relay oscillators and an additional relay oscillator. One or more relay oscillators of the group of relay oscillators may be coupled to an output oscillator of a first EBM. The one or more relay oscillators may be coupled in such a way that respective sample values of the output oscillator of the first EBM, wherein the output oscillator has progressed through thermodynamic evolution, may be stored on respective ones of the relay oscillators of the first group of one or more relay oscillators. An additional relay oscillator may be coupled to one or more of the relay oscillators, wherein the coupling enables the additional relay oscillator to take on an expectation value of the output oscillator, wherein the expectation value is derivable based at least in part on the sample values. In some embodiments, bias oscillators may be used. In some embodiments, bias oscillators may not be used. For simplicity, embodiments are given with bias oscillators, but it should be understood that is some embodiments bias oscillators may not be used for each relay oscillator of a relay gadget, however, that does not limit the embodiments to only one way or the other.

In some embodiments, thermodynamic information is relayed from a first energy-based model (EBM) 900 to a second energy-based model (EBM) 902 via relay gadget 904. The thermodynamic information of EBM 900 is outputted via output oscillator 906 and inputted into input oscillator 908 via relay gadget 904. The thermodynamic information may include, for example, samples of thermodynamic equilibrium of output oscillator 906, or the expectation value of the output oscillator 906. The expectation value is at least derivable based on samples values of the output oscillator 906. Output oscillator 906 may be governed by a potential wherein the potential follows a single-well potential, double-well potential, multi-well potential, or any generic potential that may be engineered. The output oscillator 906 may also be coupled to other oscillators belonging to EBM 900. More specifically, output oscillator 906 may be an input/output oscillator 300 of analog SoftMax gadget 106.

In some embodiments, an expectation value of one or more degrees of freedom of output oscillator 906 may be influenced by a potential of output oscillator 906 as well as couplings between output oscillator 906 and one or more oscillators belonging to first energy-based model 900. Potentials governing the dynamics of the output oscillator 906 may have multiple wells. With generic arbitrary potentials (e.g. multiple wells) and coupling between output oscillator 906 and one or more oscillators belonging to first energy-based model 900, the position degrees of freedom of the output oscillators can hop between wells. As described herein, a relay gadget provides a solution to approximate an expectation value of the output oscillator. For example, using an approximated expectation value in forwards and backwards propagation may provide better results than using a sample value, as the expectation value better represents the state of the oscillator whose degree of freedom value is being relayed to a second oscillator.

Relay gadget 904 comprises a group of relay oscillators 910 and an additional relay oscillator 912. The group of relay oscillators 910 comprises one or more relay oscillators arranged with respective bias oscillators (e.g., relay oscillator 916 arranged with bias oscillator 918). As described later, relay oscillators in oscillator group 910 may be configured and coupled in various ways (e.g. temporally and spatially) to transfer thermodynamic information. The additional relay oscillator 912 is connected to bias oscillator 920. As discussed later, the additional relay oscillator 912 may be configured and coupled in various ways to transfer thermodynamic information. For example, the group of relay oscillators 910 transfers thermodynamic information to additional relay oscillator 912 via coupling 924. Coupling 924 may be controlled by on-chip classical controller 914.

Output oscillator 906 is coupled to the one or more relay oscillators of the group of relay oscillators 910 via on-chip classical controller 914. On-chip classical controller 914 may send a pulse or a group of pulses to cause couplings between oscillators (e.g., coupling between output oscillator 906 and relay oscillator 916) or relay oscillators like 916 and a bias oscillator like 918 via pulses 930. Coupling is represented by coupling 922, 924, 926 and oscillators may be coupled or not coupled. When coupling is on, parameters of respective coupled oscillators affect the other oscillator it is coupled to. Couplings between oscillators within the group of relay oscillators 910 are not expressly shown in FIG. 9 to emphasize that the coupling may take different configurations (e.g. temporal or spatial configurations as detailed below). Nevertheless, on-chip classical controller 914 may cause a first set of one or more pulses to be emitted through controller connection 928, wherein the first set of pulses couples one or more relay oscillators of the group of relay oscillators 910 to the output oscillator 906 (e.g., turn on coupling 922). The on-chip classical controller 914 is further configured to cause a second set of one or more pulses to be emitted through path 932, wherein the second set of pulses couples one or more relay oscillators of the group of relay oscillators 910 to the additional relay oscillator 912 (e.g., turn on coupling 924). The on-chip classical controller 914 is further configured to cause a third set of one or more pulses (for example, set of pulses 938) to be emitted, wherein the third set of pulses 938 couples the additional relay oscillator 912 to the input oscillator 108 (e.g., turn on coupling 926).

In some embodiments, an additional relay oscillator 912 takes on an expectation value of an output oscillator 906 based at least in part on a coupling or couplings between a group of relay oscillators 910, wherein respective relay oscillators of group 910 comprise respective sample values of the output oscillator 906. The additional relay oscillator 912 may take on the expectation value of output oscillator 906 based at least on respective sample values taken on by respective relay oscillators. Furthermore, additional relay oscillator 912 may transfer the taken on expectation value to input oscillator 908 via controller 914 causing coupling 926 to turn on.

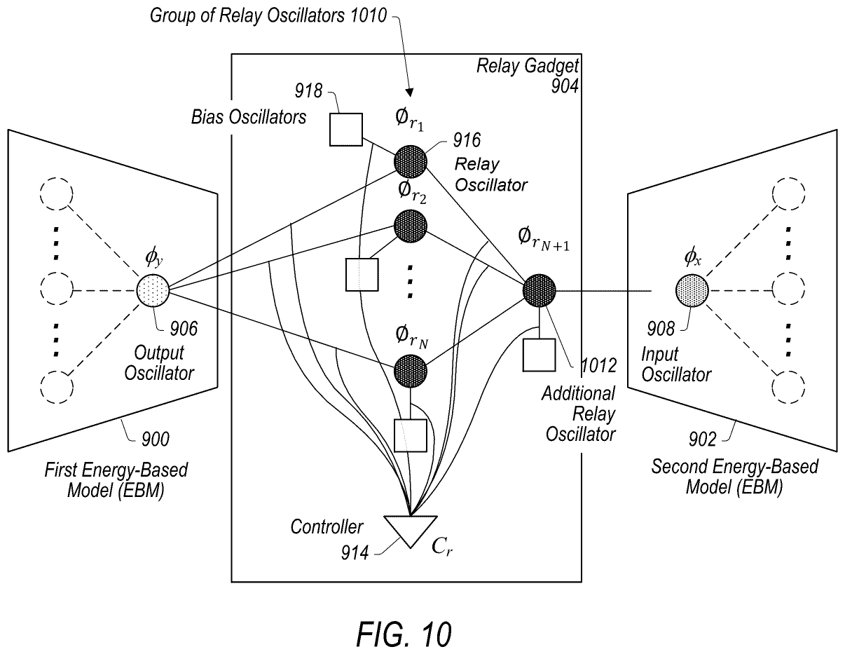

FIG. 10 is a high-level diagram illustrating a spatial analogue relay gadget, wherein respective ones of relay oscillators of a group of relay oscillators are configured to store respective sample values of an output oscillator, according to some embodiments.

In some embodiments, controller 914 sends a first set of one or more pulses wherein the first set of pulses causes output oscillator 906 of first energy-based model (EBM) 900 to be coupled to at least one or more relay oscillators {ϕᵣ_{₁}, ϕᵣ_{₂}, . . . ϕᵣ_{_{N}}}, in the group of relay oscillators 1010. The group of relay oscillators 1010 comprises a plurality of relay oscillators, wherein respective relay oscillators {ϕᵣ_{₁}, ϕᵣ_{₂}, . . . ϕᵣ_{_{N}}}, are configured to store a sample of the output oscillator 906 based at least in part on respective couplings between the respective ones of the relay oscillators (e.g., 916) of the group of relay oscillators 1010 and the output oscillator 906. The on-chip classical controller 914 is further configured to cause another set of one or more pulses to be emitted, wherein the other set of pulses turns off the respective couplings between the output oscillator 906 and the respective ones of the relay oscillator of the group of relay oscillators 1010 at different times. This may allow different samples of the output oscillator 906 to be stored on the respective ones of the relay oscillators {ϕᵣ_{₁}, ϕᵣ_{₂}, . . . ϕᵣ_{_{N}}}.

On-chip classical controller 914 may be further configured to cause a second set of one or more pulses to be emitted, wherein the second set of pulses turns on the coupling between respective ones of the relay oscillators with sample values of the output oscillator 906 to an additional relay oscillator 1012. The coupling is configured to transfer an approximation of the expectation value of output oscillator 906 based at least in part on the sample values stored on respective relay oscillators in the first group of relay oscillators 1010. Once the additional relay oscillator 1012 is tuned to the expectation value of output oscillator 906, controller 914 may cause a set of one or more pulses that may cause the additional relay oscillator 1012 to be coupled to input oscillator 908. For ease of illustration a version that includes bias oscillators is shown. However, it should be understood that in some embodiments bias oscillators may be omitted.

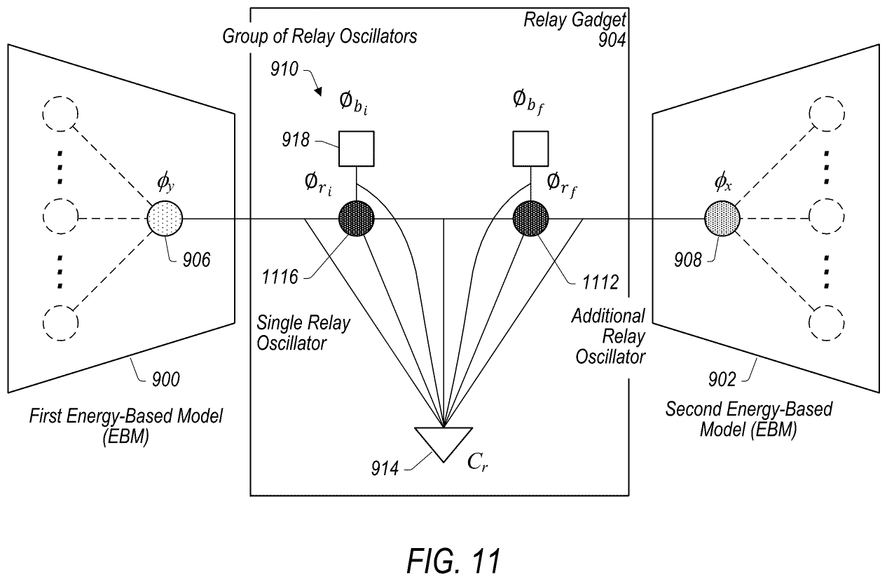

FIG. 11 is a high-level diagram illustrating a temporal analogue relay gadget, wherein a group of relay oscillators comprises a single relay oscillator, according to some embodiments.

In some embodiments, the group of relay oscillators 910 comprises a single relay oscillator 1116. The single relay oscillator 1116 is configured to store a sample of the output oscillator 906 based at least in part on the coupling between the single relay oscillator 1116 and the output oscillator 906. The coupling between output oscillator 906 and single relay oscillator 1116 is caused by a first set of one or more pulses emitted from on-chip classical controller 914. The on-chip classical controller 914 is configured to cause a second set of one or more pulses to be emitted, wherein the second set of pulses causes the single relay oscillator 1116 to be coupled to additional relay oscillator 1112. The sequence of emitting the first set of pulses and then emitting the second set of pulses may be repeated numerous times. Each instance the sequence of the sequential sets of pulses is emitted, the position of additional relay oscillator 1112 is incrementally adjusted. Each adjustment may converge the additional relay oscillator 1112 to the expectation value of output oscillator 906. For ease of illustration a version that includes bias oscillators is shown. However, it should be understood that in some embodiments bias oscillators may be omitted.

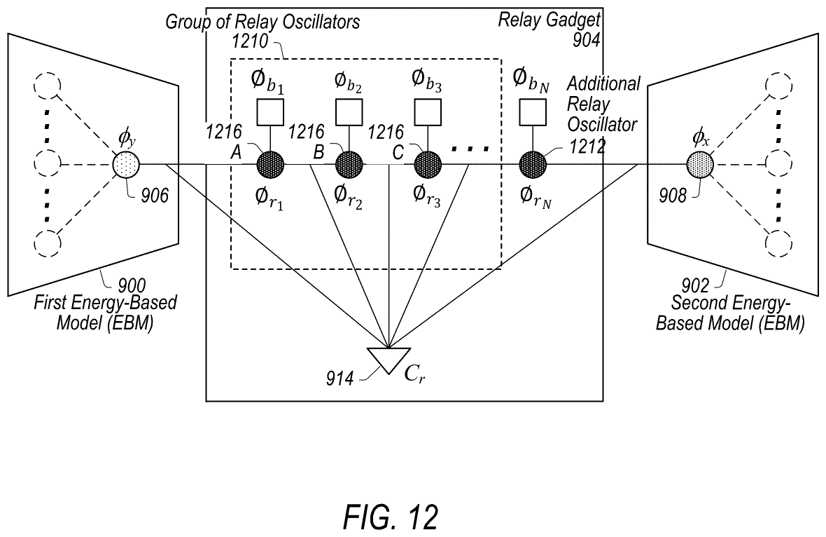

FIG. 12 is a high-level diagram illustrating a series analogue relay gadget, wherein a group of relay oscillators comprises a plurality of relay oscillators arranged in series, according to some embodiments.

FIG. 12 shows a drawing of a series analogue relay gadget 1204. The group of relay oscillators 910 comprises a plurality of relay oscillators {ϕᵣ_{₁}, ϕᵣ_{₂}, . . . } (e.g. relay oscillator 1216A, 1216B, 1216C) arranged one after another in series. Each relay oscillator has a product of mass and frequency squared. The first relay oscillator 1216A, ϕᵣ_{₁}, has the smallest product of mass and frequency squared. The next relay oscillator 1216B, ϕᵣ_{₂}, has a product of mass and frequency squared larger than the previous relay oscillator 1216A, ϕᵣ_{₁}. This trend of increasing the product of mass and frequency squared continues for each subsequent relay oscillator in the group of relay oscillators 910. As last in the chain of relay oscillators, the additional relay oscillator 1212 has the largest product of mass and frequency squared. The couplings between relay oscillators and the coupling between the output oscillator 906 and the first relay oscillator 1216A, ϕᵣ_{₁}, may be turned on at the same time and allowed to evolve thermodynamically according to Langevin dynamics. Once coupling is initiated, each successive relay oscillator takes continuous samples of the previous oscillator it is coupled to. Furthermore, each successive relay oscillator may be a closer approximation of the expectation value of the output oscillator 906. In this manner, additional relay oscillator 1212 approximates an expectation value of input oscillator 906. At this point, coupling between the additional relay oscillator 1212 and input oscillator 908 may be turned on and the thermodynamic information may be transferred to input oscillator 908. The number of relay oscillators and the timing of coupling may be chosen beforehand and optimized for a desired precision or accuracy of the expectation value of the output relay oscillator. For ease of illustration a version that includes bias oscillators is shown. However, it should be understood that in some embodiments bias oscillators may be omitted.

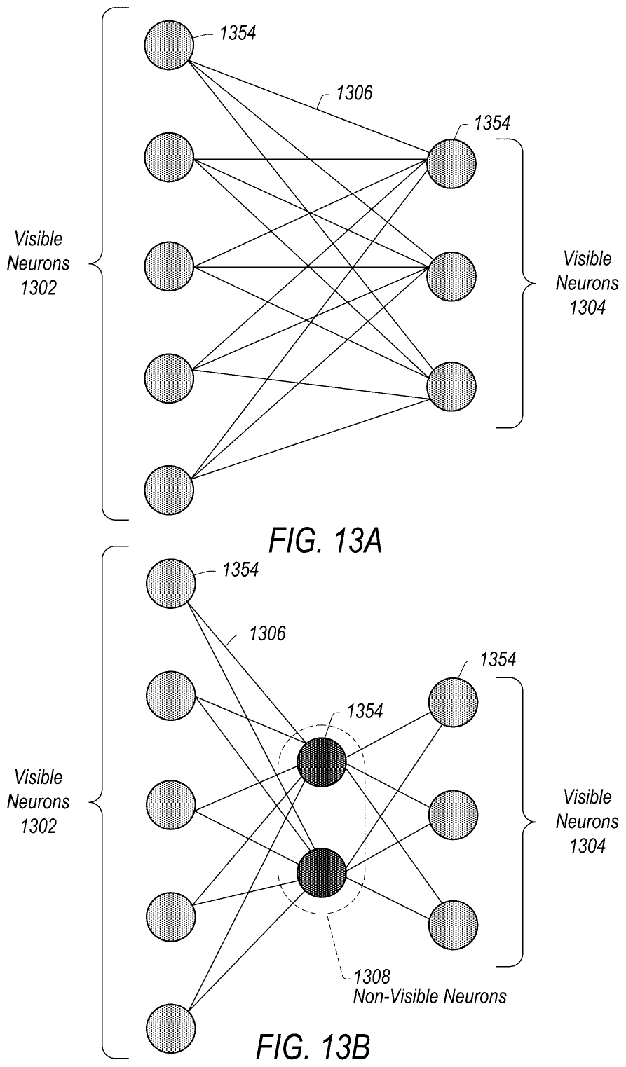

FIG. 13A illustrates example couplings between visible neurons of an energy-based model (EBM), according to some embodiments.

In some embodiments, input neurons and output neurons of an energy-based model, such as visible neurons 1302 and visible neurons 1304, may be directly linked via connected edges 1306. As shown in FIG. 13A, a given visible neuron 1302 of the five shown in the figure is connected, via edges 1306, to each of the respective three visible neurons 1304. A person having ordinary skill in the art should understand that FIG. 13A is meant to represent example embodiments of a graph architecture implemented using a thermodynamic chip that may be applied and that specific numbers of visible neurons 1302 and/or visible neurons 1304 shown in the figure are not meant to be restrictive. Additional configurations combining more/less visible neurons 1302 and/or visible neurons 1304 are also encompassed by the discussion herein. In addition, recall that neurons are logical representations of physical oscillators, such that, when describing neurons in FIGS. 13A and 13B, it should be understood that neurons and edges are implemented using oscillators and couplings.

FIG. 13B illustrates example couplings between visible neurons and non-visible neurons (e.g., hidden neurons) of an energy-based model (EBM), according to some embodiments.

In some embodiments, FIG. 13B may resemble additional example embodiments of an energy-based model architecture implemented using a thermodynamic chip. As shown in the figure, additional non-visible neurons 1308 may be used, which are respectively coupled, via edges 1306, to both visible neurons 1302 and to visible neurons 1304. Note that while the non-visible neurons are “not visible” from the perspective of inputs and outputs, the non-visible neurons may each correspond to a given oscillator. In addition, it may be noted that, in some embodiments that make use of non-visible neurons, no direct connections, via edges 1306, may be implemented between visible neurons 1302 and visible neurons 1304, but rather connections are routed firstly via non-visible neurons 1308, as shown in FIG. 13B. Couplings between visible and non-visible neurons may be additionally referred to herein as “layers” of a given energy-based model architecture that is implemented using a thermodynamic chip, according to some embodiments.

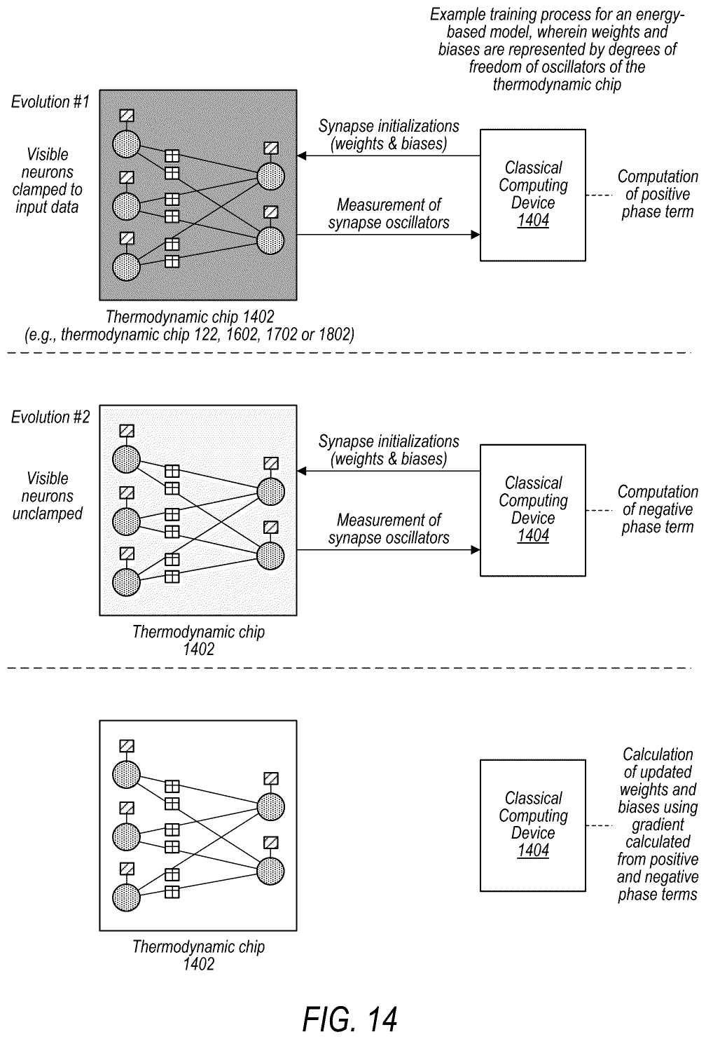

FIG. 14 is high-level diagram illustrating a process of determining weights and biases to be used in an energy-based model (EBM), wherein the weights and biases are determined using measurement values for synapse oscillators, according to some embodiments.

As shown in FIG. 14, in a first evolution, visible neurons of an energy-based model implemented on a thermodynamic chip 1402 may be clamped to input data. For example, multiple mini-batches of input data may be clamped to visible neurons for multiple evolutions used to generate a first set of measurements used to compute a positive phase term. For example, the measurements may be used by classical computing device 1404 to compute the positive phase term.

Also, in a second (or other subsequent) evolution, the visible neurons may remain unclamped, such that the visible neuron oscillators are free to evolve along with the synapse oscillators during the second (or other subsequent) evolution. Measurements may also be taken and used by the classical computing device 1404 to compute a negative phase term.

Additionally, the positive and negative phase terms computed based on the first and second sets of measurements (e.g., clamped measurements and un-clamped measurements) may be used to calculate updated weights and biases.

This process may be repeated, with the determined updated weights and biases used as initial weights and biases for a subsequent iteration. In some embodiments, inferences generated using the updated weights and biases may be compared to training data to determine if the energy-based model has been sufficiently trained. If so, the model may transition into a mode of performing inferences using the learned weights and biases. If not sufficiently trained, the process may continue with additional iterations of determining updated weights and biases.

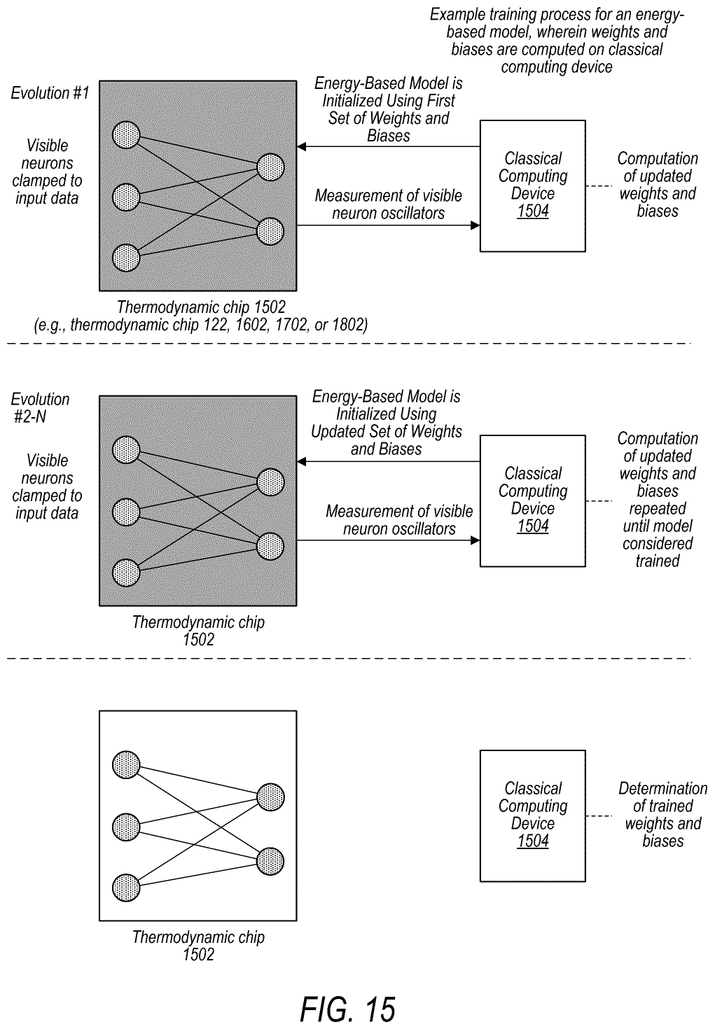

FIG. 15 is high-level diagram illustrating a process of determining weights and biases to be used in an energy-based model (EBM), wherein the weights and biases are computed using a classical computing device, according to some embodiments.

In some embodiments, updated weights and bias values may be computed iteratively by classical computing device 1504 based on inference measurements from thermodynamic chip 1502. For example, inference values may be compared to training data values, and new weights and biases may be iteratively computed until the inference values closely correspond to the training data. As can be seen in FIG. 15, in some embodiments the synapse oscillator may be omitted as degrees of freedom of the energy-based model. For example, when a classical computing device is used to iteratively determine the weight and bias values.

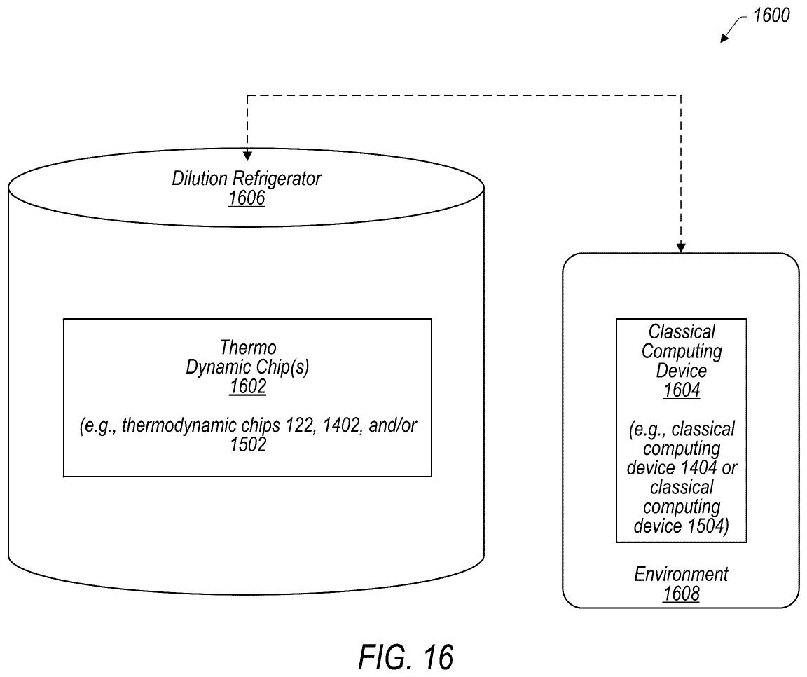

FIG. 16 is high-level diagram illustrating an example neuro-thermodynamic computer comprising a thermodynamic chip (e.g., that implements multiple energy-based models (EBMs) and a relay gadget) included in a dilution refrigerator and coupled to a classical computing device in an environment external to the dilution refrigerator, according to some embodiments.

In some embodiments, a neuro-thermodynamic computing system 1600 (as shown in FIG. 16) may be used to implement the various embodiments shown in FIGS. 1-15 and may include one or more thermodynamic chip(s) 1602 placed in a dilution refrigerator 1606. In some embodiments, classical computing device 1604 may control temperature for dilution refrigerator 1606, and/or perform other tasks, such as helping to drive a pulse drive to change respective hyperparameters of the given system and/or perform measurements. Also, the classical computing device 1604 may perform other simple computing operations, such as are needed to determine updated weights and biases.

In some embodiments, classical computing device 1604 may include one or more devices such as a field-programmable gate array (FPGA), an application specific integrated circuit (ASIC), and/or other devices that may be configured to interact and/or interface with a thermodynamic chip within the architecture of neuro-thermodynamic computer 1600. For example, such devices may be used to tune hyperparameters of the given thermodynamic system, etc. as well as perform part of the calculations necessary to determine updated weights and biases. In some embodiments, the classical computing device 1604 may be placed in an environment 1606 outside of the dilution refrigerator 1606.

As shown in FIG. 16, in embodiments where more than one thermodynamic chip is used with a relay gadget, multiple ones of the thermodynamic chips and the relay gadget may be placed in the same dilution refrigerator 1606.

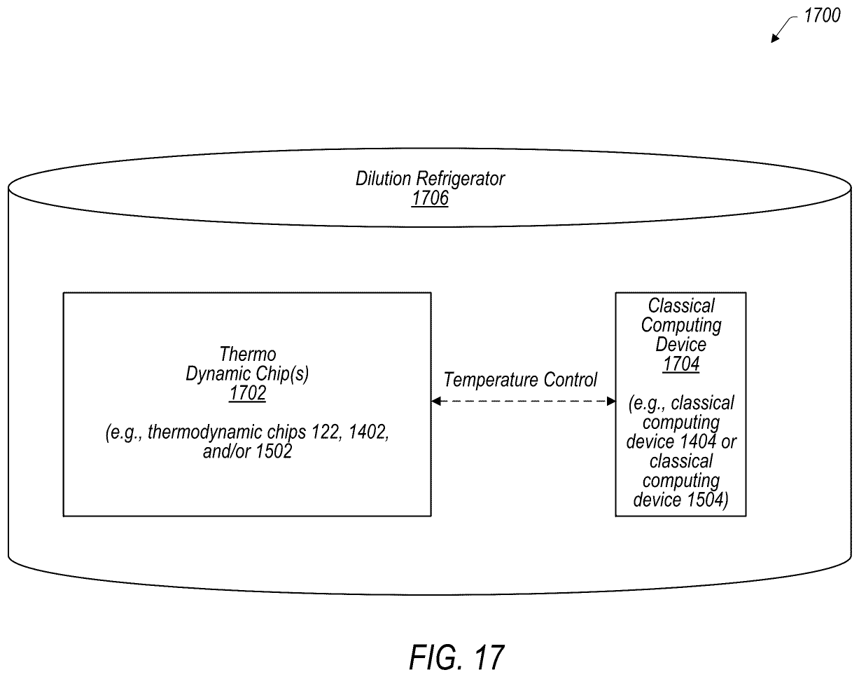

FIG. 17 is high-level diagram illustrating an example neuro-thermodynamic computer comprising a thermodynamic chip (e.g., that implements multiple energy-based models (EBMs) and a relay gadget) included in a dilution refrigerator and coupled to a classical computing device that is also included in the dilution refrigerator, according to some embodiments.

As another alternative, in some embodiments, a classical computing device used in a neuro-thermodynamic computer, such as in neuro-thermodynamic computer 1700, may be included in a dilution refrigerator with the thermodynamic chip. For example, neuro-thermodynamic computer 1700 includes both thermodynamic chip 1702 and classical computing device 1704 in dilution refrigerator 1706.

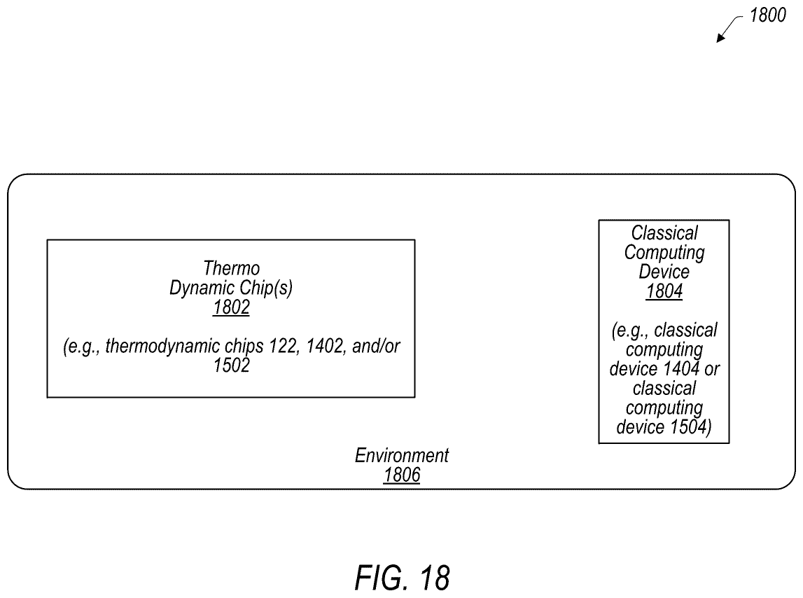

FIG. 18 is high-level diagram illustrating an example neuro-thermodynamic computer comprising one or more thermodynamic chips (e.g., that implement respective energy-based models (EBMs) and a relay gadget) coupled to a classical computing device in an environment other than a dilution refrigerator, according to some embodiments.

Also, in some embodiments, a neuro-thermodynamic computer, such as neuro-thermodynamic computer 1800, may be implemented in an environment other than a dilution refrigerator. For example, neuro-thermodynamic computer 1800 includes thermodynamic chip(s) 1802 and classical computing device 1804, in environment 1806. In some embodiments, environment 1806 may be temperature controlled and, the classical computing device (or other device) may control the temperature of environment 1806 in order to achieve a given level of evolution according to Langevin dynamics.

FIG. 19 is a high-level diagram illustrating oscillators included in a substrate of the thermodynamic chip and mapping of the oscillators to logical neurons of the thermodynamic chip, according to some embodiments.

In some embodiments, a substrate 1902 may be included in a thermodynamic chip, such as any one of the thermodynamic chips described above. Oscillators 1904 of substrate 1902 may be mapped in a logical representation 1952 to neurons 1954, as well as weights and biases (shown in FIG. 20). In some embodiments, oscillators 1904 may include oscillators with potentials ranging from a single well potential to a dual-well potential and may be mapped to visible neurons, weights, and biases.

In some embodiments, Josephson junctions and/or superconducting quantum interference devices (SQUIDS) may be used to implement and/or excite/control the oscillators 1904. In some embodiments, the oscillators 1904 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 19 for oscillator 1904. However, in some embodiments, generally speaking various non-linear flux loops may be used to implement the oscillators 1904, such as those having single-well potential, double-well potential, or various other potentials, such as a potential somewhere between a single-well potential and a double-well potential.

FIG. 20 is an additional high-level diagram illustrating oscillators included in a substrate of the thermodynamic chip mapped to logical neurons, weights, and biases of a given neuro-thermodynamic computing system, according to some embodiments.

While weights and biases are not shown in FIG. 19 for ease of illustration, respective ones of the visible neurons 1954 of FIG. 19 may each have an associated bias, and edges connecting the neurons 1954 may have associated weights. Each of the weights and biases may be mapped to oscillators in the thermodynamic chip, as well as the visible (and non-visible) neurons being mapped to oscillators in the thermodynamic chip. For example, FIG. 20 shows a portion of a thermodynamic chip, wherein weights and biases associated with a given neuron 2054 are shown. For example, bias 2056 may be a bias value for visible neuron 2054 and weights 2058 and 2060 may be weights for edges formed between visible neuron 2054 and other visible neurons of the thermodynamic chip. As shown in FIG. 20, each of the chip elements (visible neuron 2054, bias 2056, weight 2058, and weight 2060) may be mapped to separate ones of oscillators 2004. This may allow the visible neurons (and/or hidden neurons), weights, and biases to have independent degrees of freedom within a given thermodynamic chip that can separately evolve.

In some embodiments, oscillators associated with weights and biases, such as bias 2056 and weights 2058 and 2060, may be allowed to evolve during a training phase and may be held nearly constant during an inference phase. For example, in some embodiments, larger “masses” may be used for the weights and biases such that the weights and biases evolve more slowly than the visible neurons. This may have the effect of holding the weight values and the bias values nearly constant during an evolution phase used for generating inference values.

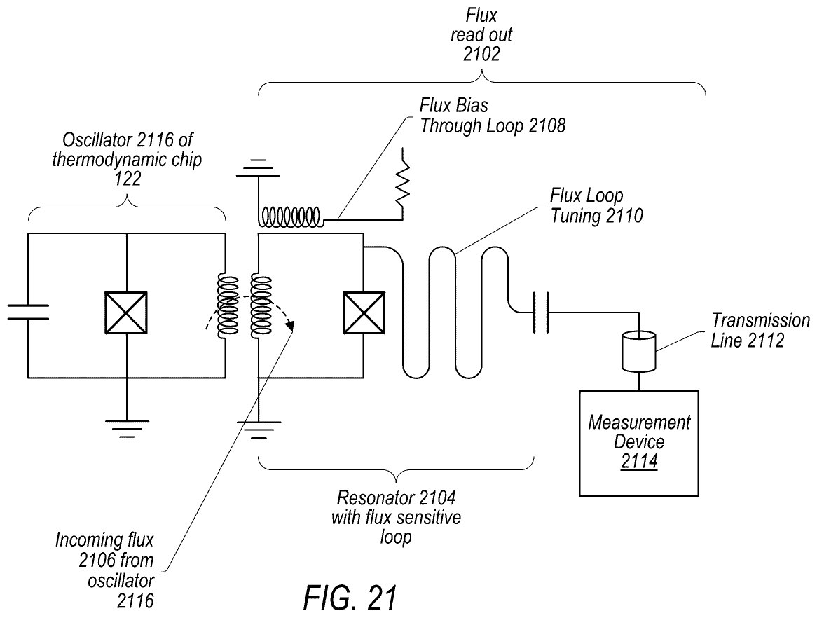

FIG. 21 illustrates an example apparatus for measuring positions of oscillators of a thermodynamic chip using a flux read-out device, according to some embodiments.

In some embodiments, a resonator with a flux sensitive loop, such as resonator 2104 of flux readout apparatus 2102 may be used to measure flux and therefore position of an oscillator 2116 of thermodynamic chip 122. Note that flux is the analog of position for the oscillators used in thermodynamic chip 122. The flux of oscillator 2116 is measured by flux readout device 2102. For example, if the inductance of oscillator 2116 changes, it will also cause a change in the inductance of resonator 2104. This in turn causes a change in the frequency at which resonator 2104 resonates. In some embodiments, measurement device 2114 detects such changes in resonator frequency of resonator 2104 by sending a signal wave through the resonator 2104. The response wave that can be measured at measurement device 2114, will be altered due to the change in resonator frequency of resonator 2104, which can be measured and calibrated to measure the flux of oscillator 2116, and therefore the position of its corresponding neuron or synapse that is coded using that oscillator.

More specifically, in some embodiments, incoming flux 2106 from resonator 2116 is sensed by the inductor of resonator 2104, wherein flux tuning loop 2110 is used to tune the flux sensed by resonator 2104. Flux bias 2108 also biases the flux to flow through resonator 2104 towards transmission line 2112. In some embodiments, transmission line 2112 may carry the signal outside of a dilution refrigerator, such as dilution refrigerator 1606 shown in FIG. 16. Also, in some embodiments, transmission line 2112 may carry the signal to a classical computing device located within the dilution refrigerator, such as is shown for dilution refrigerator 1706 in FIG. 17. Measurement device 2114 may then be used to measure the signal representing the flux and may provide a flux measurement value and/or provide a position measurement value.

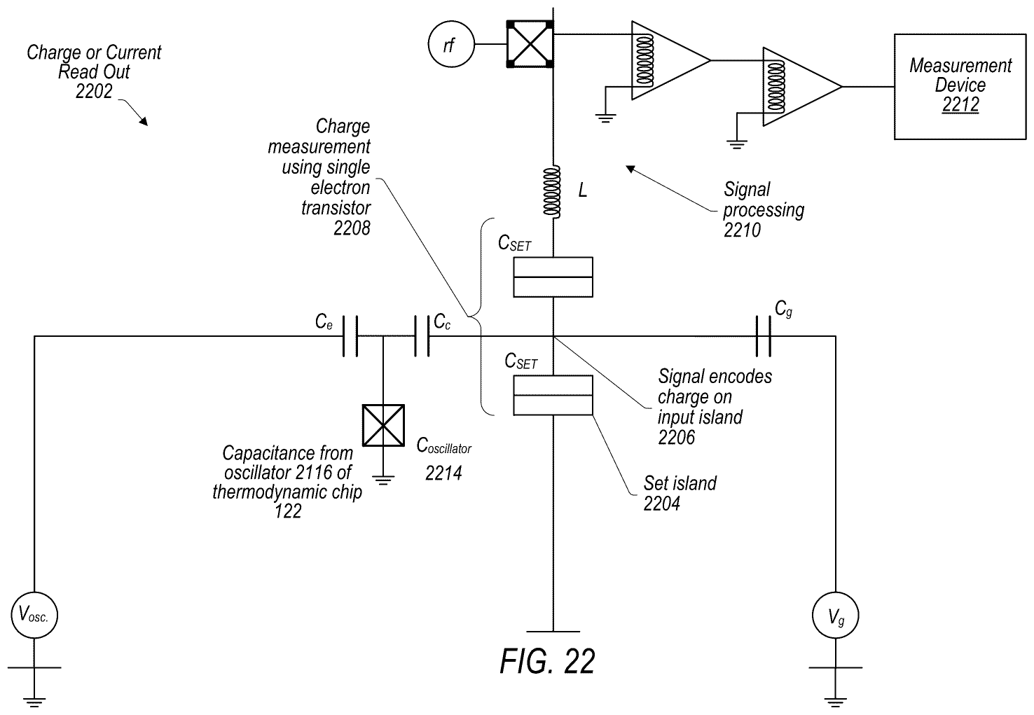

FIG. 22 illustrates an example apparatus for measuring momentums of oscillators of a thermodynamic chip using a charge read-out device, according to some embodiments.

As mentioned in the discussion of FIG. 21, flux of an oscillator of the thermodynamic chip corresponds to position. In a similar manner, a charge measurement of an oscillator corresponds to momentum. In some embodiments, a charge or current read out circuit, such as charge or current read out circuit 2202, may be used to measure charge of a given oscillator of the thermodynamic chip 122. In such an arrangement, the oscillator 2116 of thermodynamic chip 122 is represented by oscillator 2014, which is coupled to a SET island 2004 that appears as a small superconducting island from the perspective of the charge or current read out circuit 2202. For example, the charge or current read out circuit 2202 includes capacitances Ce, Cc, and Cg which are connected in the lower portion of the charge or current read out circuit 2202 as shown in FIG. 22. The Cg capacitance along with the voltage Vg is used to bias the charge on the SET island. The Ce capacitance along with the voltage V_{oscillator}, is used to bias the charge of the oscillator 2116, the Cc capacitance is the capacitance between the SET island 2204 and the oscillator 2116. The Cₛₑₜ island (e.g. SET island 2204) is used to measure the charge of the oscillator 2116 with capacitance C_{oscillator}, since the SET properties (2208) are sensitive to the charge on the SET island 2204, which is coupled to the oscillator charge. The amplifiers (cold and warm) and radio frequency signal source of signal processing 2210 are used to send the measured signal indicating the charge of the oscillator 2116 to a measurement device 2212, which may be a classical computing device, such as classical computing device 104.

### Illustrative Computer System

FIG. 23 is a block diagram illustrating an example computer system that may be used in at least some embodiments.

In some embodiments, the computing system shown in FIG. 23 may be used, at least in part, to implement any of the techniques described above in FIGS. 1-22. Furthermore, computer system 2300 may be configured to interact and/or interface with neuro-thermodynamic computing device 2380, according to some embodiments.

In the illustrated embodiment, computer system 2300 includes one or more processors 2310 coupled to a system memory 2320 (which may comprise both non-volatile and volatile memory modules) via an input/output (I/O) interface 2330. Computer system 2300 further includes a network interface 2340 coupled to I/O interface 2330. Classical computing functions may be performed on a classical computer system, such as computing computer system 2300.

Additionally, computer system 2300 includes computing device 2370 coupled to thermodynamic chip 2380. In some embodiments, computing device 2370 may be a field programmable gate array (FPGA), application specific integrated circuit (ASIC) or other suitable processing unit. In some embodiments, computing device 2370 may be a similar computing device as described in FIGS. 1-22, such as classical computing devices used to control a thermodynamic chip. In some embodiments, neuro thermodynamic computing device 2380 may be a similar neuro thermodynamic computing device as described in FIGS. 1-22, such as neuro thermodynamic computing devices implemented using thermodynamic chips.

In various embodiments, computer system 2300 may be a uniprocessor system including one processor 2310, or a multiprocessor system including several processors 2310 (e.g., two, four, eight, or another suitable number). Processors 2310 may be any suitable processors capable of executing instructions. For example, in various embodiments, processors 2310 may be general-purpose or embedded processors implementing any of a variety of instruction set architectures (ISAs), such as the x86, PowerPC, SPARC, or MIPS ISAs, or any other suitable ISA. In multiprocessor systems, each of processors 2310 may commonly, but not necessarily, implement the same ISA. In some implementations, graphics processing units (GPUs) may be used instead of, or in addition to, conventional processors.

System memory 2320 may be configured to store instructions and data accessible by processor(s) 2310. In at least some embodiments, the system memory 2320 may comprise both volatile and non-volatile portions; in other embodiments, only volatile memory may be used. In various embodiments, the volatile portion of system memory 2320 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 2320 as code 2325 and data 2326.

In some embodiments, I/O interface 2330 may be configured to coordinate I/O traffic between processor 2310, system memory 2320, computing device 2370, and any peripheral devices in the computer system, including network interface 2340 or other peripheral interfaces such as various types of persistent and/or volatile storage devices. In some embodiments, I/O interface 2330 may perform any necessary protocol, timing or other data transformations to convert data signals from one component (e.g., system memory 2320) into a format suitable for use by another component (e.g., processor 2310). In some embodiments, I/O interface 2330 may include support for devices attached through various types of peripheral buses, such as a variant of the Peripheral Component Interconnect (PCI) bus standard or the Universal Serial Bus (USB) standard, for example. In some embodiments, the function of I/O interface 2330 may be split into two or more separate components, such as a north bridge and a south bridge, for example. Also, in some embodiments some or all of the functionality of I/O interface 2330, such as an interface to system memory 2320, may be incorporated directly into processor 2310.

Network interface 2340 may be configured to allow data to be exchanged between computing device 2300 and other devices 2360 attached to a network or networks 2350, such as other computer systems or devices. In various embodiments, network interface 2340 may support communication via any suitable wired or wireless general data networks, such as types of Ethernet network, for example. Additionally, network interface 2340 may support communication via telecommunications/telephony networks such as analog voice networks or digital fiber communications networks, via storage area networks such as Fibre Channel SANs, or via any other suitable type of network and/or protocol.

In some embodiments, system memory 2320 may represent one embodiment of a computer-accessible medium configured to store at least a subset of program instructions and data used for implementing the methods and apparatus discussed in the context of FIG. 1 through FIG. 22. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 2300 via I/O interface 2330. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 2300 as system memory 2320 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 2340. Portions or all of multiple computing devices such as that illustrated in FIG. 23 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### Conclusion

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the figures above and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system comprising:
one or more controllers configured to initialize one or more thermodynamic chips;
the one or more thermodynamic chips, comprising:
a plurality of oscillators, wherein the plurality of oscillators comprises:
a set of oscillators configured to generate SoftMax data samples based on input data;
a plurality of sets of oscillators, each set implementing a respective energy-based model, configured to process the input data; and
a summation gadget comprising one or more summation oscillators, wherein the summation gadget is configured to receive output from the respective energy-based models;
wherein the SoftMax data samples weight the output of the respective energy-based models; and
wherein the summation gadget processes the output from the respective energy-based models to generate a mixed result of the respective energy-based models.

2. The system of claim 1, wherein the summation gadget generates the mixed result of the respective energy-based models by combining the outputs from the respective energy-based models which have been weighted in accordance with the SoftMax data samples to generate a weighted average of the outputs from the respective energy-based models.

3. The system of claim 1, wherein:
the set of oscillators configured to generate the SoftMax data samples has one or more learnable SoftMax parameters;
the one or more learnable SoftMax parameters may be trained to cause the set of oscillators configured to generate the SoftMax data samples to generate one or more inferences using Langevin dynamics; and
the one or more inferences are the SoftMax data samples.

4. The system of claim 1, wherein:
each of the plurality of sets of oscillators implementing respective ones of the energy-based models has one or more learnable energy-based model parameters; and
the one or more learnable energy-based model parameters may be trained to cause the plurality of sets of oscillators implementing respective ones of the energy-based models to generate one or more inferences using Langevin dynamics; and
the one or more inferences are the output.

5. The system of claim 4, wherein the training is performed using positive and negative phase terms.

6. The system of claim 4, wherein the training is performed during said initialization by the or more controllers.

7. The system of claim 1, wherein a given oscillator of the plurality of oscillators:
represents a neuron or a synapse, wherein the given oscillator that represents a synapse is a weighting value coordination oscillator or a bias value coordination oscillator; and
has a configuration with one or more other oscillators of the plurality of oscillators.

8. The system of claim 1, wherein the SoftMax data samples are:
one hot-encoded vectors which in aggregate indicate one or more SoftMax values; or
vectors which indicate SoftMax values.

9. The system of claim 1, further comprising one or more oscillators configured to modify the input data using a bias parameter or a matrix parameter.

10. The system of claim 1, wherein each of the sets of the plurality of sets of oscillators comprises an energy-based model and a relay oscillator, wherein the relay oscillator provides output from the energy-based model to the summation gadget.

11. The system of claim 1, wherein the one or more thermodynamic chips are positioned within one or more dilution refrigerators.

12. One or more thermodynamic chips, comprising:
a thermodynamic mixture of experts gadget comprising:
one or more oscillators having an engineered potential that implements a summation function to generate a mixed result of output of a plurality of energy-based models;
wherein the output of the plurality of energy-based models is weighted by SoftMax data samples.

13. The one or more thermodynamic chips of claim 12, wherein the thermodynamic mixture of experts gadget generates the mixed result by combining the output of the plurality of energy-based models that is weighted in accordance with the SoftMax data samples to generate a weighted average of the output of the plurality of energy-based models.

14. The one or more thermodynamic chips of claim 12, further comprising:
a set of oscillators configured to generate the SoftMax data samples using modified input data;
one or more oscillators configured to generate the modified input data;
a plurality of sets of oscillators, each set implementing a respective one of the energy-based models, configured to process initial input data.

15. The one or more thermodynamic chips of claim 14, wherein the one or more oscillators configured to generate the modified input data multiply initial input data by a bias parameter or multiply the initial input data by a matrix parameter.

16. The one or more thermodynamic chips of claim 14, wherein each of the sets of the plurality of sets of oscillators comprises a given energy-based model and a relay oscillator, wherein the relay oscillator provides a respective output from the given energy-based model to the one or more oscillators having the engineered potential that implements the summation function.

17. The one or more thermodynamic chips of claim 16, wherein the relay oscillators are static relay oscillators or expectation value relay oscillators.

18. The one or more thermodynamic chips of claim 14, wherein:
the set of oscillators configured to generate the SoftMax data samples has one or more learnable SoftMax parameters;
the one or more learnable SoftMax parameters may be trained to cause the set of oscillators configured to generate the SoftMax data samples to generate one or more inferences using Langevin dynamics; and
the one or more inferences are the SoftMax data samples.

19. The one or more thermodynamic chips of claim 14, wherein:
each of the plurality of sets of oscillators implementing respective ones of the energy-based models has one or more learnable energy-based model parameters; and
the one or more learnable energy-based model parameters may be trained to cause the plurality of sets of oscillators implementing respective ones of the energy-based models to generate one or more inferences using Langevin dynamics; and
the one or more inferences are the mixed result.

20. The one or more thermodynamic chips of claim 19, wherein the training is performed using positive and negative phase terms.

21. The one or more thermodynamic chips of claim 19, wherein the training is performed during the initialization by the controller.

22. The one or more thermodynamic chips of claim 12, wherein an oscillator of the plurality of oscillators:
represents a neuron or a synapse, wherein an oscillator that represents a synapse is a weighting value coordination oscillator or a bias value coordination oscillator; and
has a configuration with one or more other oscillators of the plurality of oscillators.

23. The one or more thermodynamic chips of claim 12, wherein the SoftMax data samples are:
one hot-encoded vectors which in aggregate indicate one or more SoftMax values; or
vectors which indicate SoftMax values.

24. A method, comprising:
initializing one or more thermodynamic chips with input data, the one or more thermodynamic chips comprising:
a plurality of oscillators, wherein the plurality of oscillators comprises:
a set of oscillators configured to generate SoftMax data samples based on the input data;
a plurality of sets of oscillators, each set implementing a respective energy-based model, configured to process the input data; and
one or more summation oscillators, wherein the one or more summation oscillators are configured to receive output from the respective energy-based models and process the output from the respective energy-based models to generate a mixed output data;
wherein the SoftMax data samples weight the output from the respective energy-based models; and
receiving mixed output data from the one or more thermodynamic chips.

25. The method of claim 24, wherein the one or more summation oscillators generate the mixed output data by combining the output from the respective energy-based models in accordance with the SoftMax data samples to generate a weighted average of the output from the respective energy-based models.

26. The method of claim 24, wherein:
the set of oscillators configured to generate the SoftMax data samples has one or more learnable SoftMax parameters;
the one or more learnable SoftMax parameters may be trained to cause the set of oscillators configured to generate the SoftMax data samples to generate one or more inferences using Langevin dynamics; and
the one or more inferences are the SoftMax data samples.

27. The method of claim 24, wherein:
each of the plurality of sets of oscillators implementing respective ones of the energy-based models has one or more learnable energy-based model parameters; and
the one or more learnable energy-based model parameters may be trained to cause the plurality of sets of oscillators implementing respective ones of the energy-based models to generate one or more inferences using Langevin dynamics; and
the one or more inferences are the mixed output data.

28. The method of claim 27, further comprising:
performing the training using positive and negative phase terms.

29. The method of claim 27, further comprising:
performing the training during the initialization by the controller.

30. The method of claim 24, wherein a given oscillator of the plurality of oscillators:
represents a neuron or a synapse, wherein the given oscillator that represents a synapse is a weighting value coordination oscillator or a bias value coordination oscillator; and
has a configuration with one or more other oscillators of the plurality of oscillators.

31. The method of claim 24, wherein the SoftMax data samples are:
one hot-encoded vectors which in aggregate indicate one or more SoftMax values; or
vectors which indicate SoftMax values.

32. The method of claim 24, wherein one or more oscillators are further configured to modify the input data using a bias parameter or a matrix parameter.

33. The method of claim 24, wherein each of the sets of the plurality of sets of oscillators comprises an energy-based model and a relay oscillator, wherein the relay oscillator provides output from the energy-based model to the one or more summation oscillators.

34. The method of claim 33, wherein the relay oscillators are static relay oscillators or expectation value relay oscillators.
